(19) United States
(12) Patent Application Publication
(10) Pub. No.: US 2026/0292874 A1
(43) Pub. Date: Sep. 24, 2026

(54) Systems and Methods for Concurrent Clear Channel Assessment

(71) Applicant: Cisco Technology, Inc., San Jose, CA (US)

(72) Inventors: Matthew A. Silverman, Shaker Heights, OH (US); Brian Hart, Los Altos Hills, CA (US)

(21) Appl. No.: 19/577,180

(22) Filed: Mar. 24, 2026

Related U.S. Application Data
(60) Provisional application No. 63/776,838, filed on Mar. 24, 2025.

(51) Int. Cl. H04W 74/0808

(52) U.S. Cl. CPC H04W 74/0808

(57) ABSTRACT

Systems and methods for concurrent clear channel assessment in wireless networks are provided. A network device includes a processor, at least one network interface controller, and a memory comprising a concurrent clear channel assessment logic. The network device identifies a first target station for a first data transmission and a second target station for a second data transmission. The network device directs a first radio frequency beam towards the first target station and a second radio frequency beam towards the second target station. Furthermore, the network device initiates a first clear channel assessment countdown for the first target station concurrently with a second clear channel assessment countdown for the second target station based on a radio frequency isolation between the first radio frequency beam and the second radio frequency beam. The device then transmits a first physical layer protocol data unit to the first target station upon completion.

### CROSS-REFERENCE TO RELATED APPLICATIONS

The present application claims the benefit and priority to U.S. Provisional Patent Application No. 63/776,838, filed Mar. 24, 2025, the entire contents of each are hereby incorporated by reference.

### FIELD

The present disclosure relates to wireless communications. More particularly, the present disclosure relates to performing concurrent clear channel assessments across different radio frequency beam directions.

### BACKGROUND

Wireless local area networks are widely utilized to connect devices and facilitate data exchange. As the demand for high-throughput data transmission grows, wireless communication standards continue to evolve to utilize new frequency bands. For instance, traditional sub-7 GHz bands are becoming crowded, prompting the exploration of higher frequency spectrums, such as the 45 GHz to 71 GHz bands, to provide greater bandwidth.

Operating in higher frequency bands, such as the millimeter wave spectrum, presents unique radio frequency propagation challenges. Signals in these higher frequency bands experience significant path loss and have a very limited range. To overcome these propagation limits and establish viable communication links, network devices often rely on directional beamforming techniques. By utilizing phased array antennas, a transmitter can apply phase shifts to focus radio frequency energy into a narrow beam directed at a specific receiver.

In shared wireless mediums, devices typically employ contention-based access protocols to mitigate collisions and ensure fair access to the channel. A common protocol relies on Carrier Sense Multiple Access with Collision Avoidance (CSMA/CA). Under these protocols, a device intending to transmit data first performs a clear channel assessment to determine whether the wireless medium is idle or busy. If the medium is sensed as busy, the device backs off, often using a random backoff counter, before attempting to transmit again.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a conceptual depiction of a communication layer architecture, in accordance with various embodiments of the disclosure;

FIG. 3 is a diagram illustrating clear channel assessment directions associated with a station in a wireless network in accordance with various embodiments of the disclosure;

FIG. 4 is a block diagram illustrating a transceiver with multiple phased antenna arrays in accordance with various embodiments of the disclosure;

FIG. 5 is a conceptual diagram illustrating phase shifts in a phased array antenna in accordance with various embodiments of the disclosure;

FIG. 6 is a block diagram illustrating a transceiver configured for concurrent clear channel assessments across multiple beams in accordance with various embodiments of the disclosure;

FIG. 7 is a timing diagram illustrating concurrent clear channel assessment countdowns with a paused backoff in accordance with various embodiments of the disclosure;

FIG. 8 is a timing diagram illustrating path-specific operations during concurrent clear channel assessment and transmission in accordance with various embodiments of the disclosure;

FIG. 9 is a timing diagram illustrating an early clear channel assessment for a second transmission following a first transmission in accordance with various embodiments of the disclosure;

FIG. 10 is a timing diagram illustrating concurrent clear channel assessment while receiving a block acknowledgment in accordance with various embodiments of the disclosure;

FIG. 11 is a schematic diagram of a network environment including access points and client devices in accordance with various embodiments of the disclosure;

FIG. 12 is a flowchart showing a process for concurrent clear channel assessments in accordance with various embodiments of the disclosure;

FIG. 13 is a flowchart showing a process for managing concurrent backoff counters in accordance with various embodiments of the disclosure;

FIG. 14 is a flowchart showing a process for receiving directional transmissions and transmitting responses in accordance with various embodiments of the disclosure;

FIG. 15 is a flowchart showing a process for performing a supplemental omnidirectional clear channel assessment for response frames in accordance with various embodiments of the disclosure;

FIG. 16 is a flowchart showing a process for allocating reception and transmission paths in accordance with various embodiments of the disclosure;

FIG. 17 is a flowchart showing a process for performing a directional clear channel assessment prior to an initial control frame in accordance with various embodiments of the disclosure;

FIG. 18 is a flowchart showing a process for performing a directional clear channel assessment prior to an initial control response in accordance with various embodiments of the disclosure; and

FIG. 19 is a conceptual block diagram of a device suitable for configuration with a concurrent clear channel assessment logic for implementing the functionality and various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DESCRIPTION OF EXAMPLE EMBODIMENTS

### OVERVIEW

In some embodiments, a client device includes a processor, at least one network interface controller configured to provide access to a network, and a memory communicatively coupled to the processor, wherein the memory includes a concurrent clear channel assessment logic. The logic is configured to direct a receiving radio frequency beam, receive a directional physical layer protocol data unit transmission, process the directional physical layer protocol data unit transmission, determine that a response frame is required, and transmit a directional response frame.

In some embodiments, a method of concurrent clear channel assessment includes identifying, by a network device, a first target station for a first data transmission and a second target station for a second data transmission, directing, by the network device, a first radio frequency beam towards the first target station and a second radio frequency beam towards the second target station, initiating, by the network device, a first clear channel assessment countdown for the first target station concurrently with a second clear channel assessment countdown for the second target station based on a radio frequency isolation between the first radio frequency beam and the second radio frequency beam, and transmitting, by the network device, a first physical layer protocol data unit to the first target station upon completion of the first clear channel assessment countdown.

### EXAMPLE EMBODIMENTS

In response to the problems and issues described herein, embodiments of the present disclosure can provide systems and methods for concurrent clear channel assessments across different radio frequency beam directions. As wireless communication networks expand into millimeter wave frequency bands to support higher data throughput, traditional contention-based access protocols can become inefficient. Because these high-frequency networks might rely heavily on narrow, highly directional beams to overcome severe path loss, an omnidirectional assessment of the wireless medium can cause devices to unnecessarily defer their transmissions. By enabling network devices to perform independent channel assessments tailored to specific spatial sectors, the present disclosure can overcome these legacy bottlenecks and drastically improve spatial reuse.

To facilitate this advanced medium access, a network device can be configured with multiple independent transceiver paths, each connected to a separate phased antenna array. These arrays can apply precise analog or digital phase shifts to electronically steer radio frequency energy toward different target stations located in distinct geographic areas. When a device has data queued for multiple clients, it can point its respective beams toward each client and initiate simultaneous backoff countdowns. Because the beams are highly directional, the energy detected in one spatial sector might not correlate with the energy present in another, allowing the device to efficiently manage multiple transmission queues in parallel without violating collision avoidance rules.

In certain situations, the spatial isolation between multiple active beams might not be entirely sufficient to allow completely independent operations. If a device begins an active data transmission on a primary path, the emitted radio frequency energy could potentially leak into the reception circuitry of a secondary path that is currently performing a clear channel assessment. To mitigate this internal interference, the network device can dynamically pause the backoff counter associated with the secondary path during the active transmission. Once the primary transmission concludes and the internal interference subsides, the secondary path can seamlessly resume its countdown from the exact point where it was paused, thereby preserving the time already invested in sensing the medium.

Furthermore, the flexibility of the independent transceiver paths can enable dynamic resource pooling to improve link reliability. During a paused backoff period, the network device might temporarily reassign the secondary phased antenna array to point toward the primary target station. By combining the output of multiple arrays, the device can augment the transmission power and ensure the successful delivery of a critical payload. Immediately following this cooperative transmission, the secondary array can snap back to its original assigned sector and continue its interrupted clear channel assessment, balancing the need for robust signal strength with the goal of overall network latency reduction.

The disclosed systems can also intelligently manage the complex timing requirements associated with control responses and consecutive transmissions. For example, while one transceiver path remains focused on a client to receive an expected block acknowledgment, another available path can perform an early clear channel assessment directed at a new target. This overlapping of reception and sensing tasks can effectively hide the assessment delay within the existing transmit opportunity window. Additionally, to ensure that low-speed response frames are not corrupted by nearby hidden nodes, the network device might supplement its directional sensing with a brief omnidirectional clear channel assessment prior to dispatching its data

Often a clear channel assessment can be understood as a fundamental collision avoidance mechanism utilized by devices operating within a shared wireless medium. Before a network node attempts to transmit a data payload, it must first listen to the radio frequency environment to ensure that no other device is currently broadcasting. This process is functionally similar to a person checking to see if a conversation has paused before deciding to speak. If the device detects radio frequency energy above a certain threshold, it assumes the channel is busy and initiates a random backoff countdown, waiting for a specified duration before checking the medium again. This constant monitoring helps maintain order and prevents data packets from colliding and corrupting one another in mid-air.

In the context of advanced wireless networks, the concept of a clear channel assessment evolves from a simple omnidirectional listening state to a highly targeted spatial evaluation. Instead of listening to the entire surrounding environment, a device can restrict its sensing capabilities to a narrow geographic corridor. By listening only in the specific direction of an intended receiver, the device can effectively ignore high-power transmissions occurring in unrelated sectors of the network. This directional approach allows multiple devices to conduct concurrent assessments and simultaneous transmissions, vastly increasing the overall efficiency and data throughput of the local network without violating the core principles of collision avoidance.

Those skilled in the art will recognize that a phased array antenna is a sophisticated hardware component comprised of multiple individual radiating elements working in unison to shape and steer electromagnetic waves. Unlike traditional antennas that physically rotate to change their transmission direction, a phased array utilizes electronic phase shifters to delay the signal reaching each discrete element by a precise fraction of a second. When these slightly delayed signals are emitted, they constructively interfere in a specific desired direction while destructively interfering in unwanted directions. This phenomenon results in a highly focused radio frequency beam that can be electronically swept across a coverage area almost instantaneously.

The rapid agility provided by a phased array antenna is critical for managing dense groups of mobile clients in modern wireless environments. Because the beam steering is entirely electronic, a network gateway can transmit a packet to a device on one side of a room and immediately snap its focus to a completely different device on the opposite side of the room within microseconds. Furthermore, a single large array can often be logically partitioned to generate multiple independent beams concurrently. This spatial isolation enables the network to pool its hardware resources dynamically, boosting signal strength for distant clients or servicing multiple distinct geographic sectors simultaneously without causing internal crosstalk.

In various embodiments, millimeter wave frequencies refer to a specific band of the electromagnetic spectrum located at much higher frequencies than those utilized by legacy wireless standards. These extremely high frequencies correspond to very short wavelengths, typically measuring between one and ten millimeters. The primary advantage of operating within this spectral region is the availability of massive contiguous blocks of unallocated bandwidth. This vast bandwidth acts like a massive superhighway for digital information, allowing devices to transmit large amounts of data per second with incredibly low latency, which is essential for demanding applications like uncompressed video streaming and real-time automated control systems.

Despite their immense capacity, millimeter wave frequencies present unique physical propagation challenges that dictate the design of the overarching network architecture. These short waves suffer from severe atmospheric attenuation and struggle to penetrate solid obstacles such as walls, heavy foliage, or even human bodies. To overcome this rapid signal degradation, devices must abandon traditional omnidirectional broadcasting, which scatters energy inefficiently, in favor of the highly focused directional beams generated by phased arrays. Consequently, millimeter wave networks rely heavily on continuous spatial tracking, rapid beam steering, and complex concurrent clear channel assessments to maintain stable, line-of-sight or precisely reflected communication links between endpoints.

Aspects of the present disclosure may be embodied as an apparatus, a system, a method, or a computer program product. Accordingly, aspects of the present disclosure may take the form of an entirely hardware embodiment, inserted into a prior deployment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. The executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user’s computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in numerous additional embodiments, may alternatively be embodied by or implemented as a component.

A circuit, as used herein, comprises a set of one or more electrical and/or electronic components providing one or more pathways for electric current. In still yet further embodiments, a circuit may include a return pathway for electric current, so that the circuit is a closed loop. In still yet additional embodiments, however, a set of components that does not include a return pathway for electric current may be referred to as a circuit (e.g., an open loop). For example, an integrated circuit may be referred to as a circuit regardless of whether the integrated circuit is coupled to ground as a return pathway for electric current or not. In several embodiments, a circuit may include a portion of an integrated circuit, an integrated circuit, a set of integrated circuits, a set of non-integrated electrical and/or electrical components with or without integrated circuit devices, or the like. In several more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in various embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B, or C” or “A, B, and/or C” mean “any of the following: A; B; C; A and B; A and C; B and C; A, B, and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

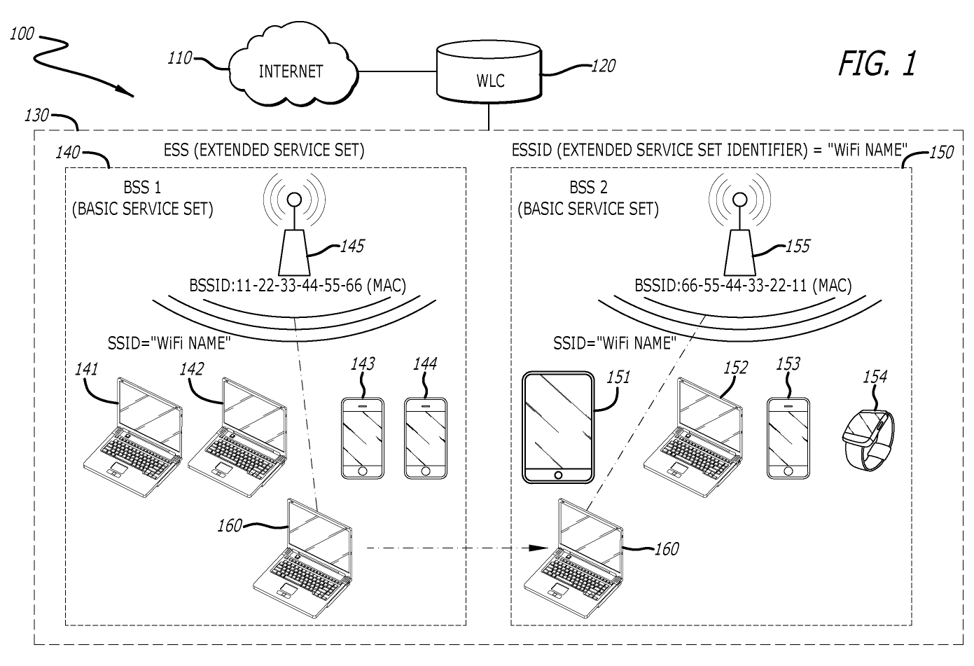

Referring to FIG. 1, a schematic block diagram of a wireless local networking system 100, in accordance with various embodiments of the disclosure is shown. Wireless local networking standards can play a crucial role in enabling seamless communication and connectivity between various devices within localized areas. One of the most prevalent standards can be Wi-Fi, which might be based on the Institute of Electrical and Electronics Engineers protocols. Emerging technologies and future iterations can continue to refine wireless networking standards, potentially ensuring the evolution of efficient, reliable, and secure wireless communication.

In many embodiments, an internet 110 can be a public network connected to the wireless local networking system 100. The internet 110 can serve as a gateway to external data resources and services for various devices within the network. Access to the internet 110 might be facilitated through wired or wireless connections established by intermediate network controllers and access points. Often, the internet 110 can provide the backhaul connectivity required for stations to communicate with remote servers or other networks.

In a number of embodiments, a wireless network controller 120 can be connected to a public network such as the internet 110. The wireless network controller 120 can be configured to manage a plurality of access points and their associated wireless parameters. Often, the wireless network controller 120 can handle centralized functions such as security authentication, radio resource management, and mobility control. The wireless network controller 120 can be in communication with an extended service set to coordinate traffic flow across multiple network segments.

In more embodiments, an extended service set 130 can be a sophisticated wireless network architecture designed to provide seamless coverage across a larger area. This extended service set 130 can span environments such as homes or offices that might be too expansive for reliable coverage by a single access point. The extended service set 130 can be created through the collaboration of multiple access points, potentially presenting itself to users as a unified and continuous network experience. By integrating one or more infrastructure basic service sets within a common logical network segment, the extended service set 130 might allow users to roam between different physical locations without losing connectivity.

In additional embodiments, a first basic service set 140 can represent a subset of the extended service set 130. The first basic service set 140 can be comprised of a logical grouping of devices that might share common communication characteristics, such as radio frequency and security settings. Management of the first basic service set 140 can be performed by a dedicated access point to ensure efficient data transmission among its associated stations. In many embodiments, the first basic service set 140 can define a specific geographical area where wireless devices can interact with the network.

In various embodiments, a first access point 145 can be a wireless device configured to provide network access to stations within the first basic service set 140. The first access point 145 can bridge wireless traffic from associated devices to a larger wired or wireless network infrastructure. Often, the first access point 145 can broadcast beacon frames to announce the availability of the first basic service set 140 and its supported features. The first access point 145 can be configured to perform beamforming and concurrent clear channel assessments to avoid congestion or interference on its current operating frequency.

In still more embodiments, a first notebook 141 can be a user end device that might connect to the first basic service set 140. The first notebook 141 can be configured with a wireless interface to communicate with an associated access point using standardized protocols. Often, the first notebook 141 can be utilized by a user to access local network resources or the internet 110. The first notebook 141 can transmit and receive data frames that might be processed by the wireless infrastructure.

In numerous embodiments, a second notebook 142 can be another mobile computing device associated with the first basic service set 140. The second notebook 142 might operate alongside other stations to exchange information across the wireless local networking system 100. Like other stations, the second notebook 142 can be assigned a unique address for identification within the network layers. The second notebook 142 can be configured to support various iterations of wireless standards to potentially achieve high-speed connectivity.

In some embodiments, a first phone 143 can be a cellular or mobile phone operating as a station within the first basic service set 140. The first phone 143 can facilitate wireless interaction with the network for a user while in a mobile environment. Often, the first phone 143 might be configured with a transceiver capable of handling both cellular and Wi-Fi signals. The first phone 143 can participate in the data exchange processes managed by the wireless local networking system 100.

In many embodiments, a second phone 144 can be another wireless communication device connected to the first basic service set 140. The second phone 144 can transmit management and data frames to an associated access point to maintain its network presence. Like other user end devices, the second phone 144 can be configured with specific parameters to prioritize different types of traffic. The second phone 144 might be capable of receiving communications over targeted radio frequency beams and adjusting its radio settings accordingly.

In further embodiments, a second basic service set 150 can be another logical network segment within the extended service set 130. The second basic service set 150 can provide a separate environment for wireless devices to communicate using shared parameters. Management of the second basic service set 150 might be handled by an independent access point to coordinate medium access. Like other service sets, the second basic service set 150 can be configured with specific identifiers and security credentials to protect data integrity.

In many embodiments, a second access point 155 can be a wireless gateway managing communication within the second basic service set 150. The second access point 155 can be in communication with the wireless network controller 120 to ensure cohesive operation across the extended service set 130. Often, the second access point 155 can transmit beacon frames to confirm its presence and coordinate multiple independent clear channel assessments. The second access point 155 might be configured to perform regulatory checks before resuming service on restricted frequencies.

In additional embodiments, a first tablet 151 can be a portable computing device associated with the second basic service set 150. The first tablet 151 can use a wireless interface to interact with the networking infrastructure and access various services. Often, the first tablet 151 can be used for media consumption or productivity tasks that might require a stable wireless connection. The first tablet 151 can be configured to receive and parse targeted data frames containing millimeter wave transmission parameters.

In yet further embodiments, a fourth notebook 152 can be a computing station operating within the second basic service set 150. The fourth notebook 152 can transmit data to and receive data from an associated access point to facilitate communication with other network nodes. Like other notebooks in the wireless local networking system 100, the fourth notebook 152 can be configured with standardized protocols for link-layer interactions. The fourth notebook 152 can be identified within the second basic service set 150 by its unique hardware address.

In some embodiments, a third phone 153 can be a mobile device connected to the second basic service set 150. The third phone 153 can participate in the wireless communication environment by exchanging frames with the second access point 155. Often, the third phone 153 might be utilized for voice or video communication that can be sensitive to network latency. The third phone 153 can be configured to recognize signaling bits that indicate support for concurrent transmissions.

In certain embodiments, a first watch 154 can be a wearable computing device that might connect to the second basic service set 150. The first watch 154 can represent a compact station with wireless capabilities for data synchronization and notification management. Due to its size and battery constraints, the first watch 154 might frequently utilize power-saving mechanisms to reduce its energy consumption. The first watch 154 can be configured to wake up at precise times to receive management frames from the network infrastructure.

In many embodiments, a third notebook 160 can be a station that might be communicatively connected to both the first basic service set 140 and the second basic service set 150. In this setup, the third notebook 160 can be seen to roam from the physical area serviced by the first basic service set 140 and into the physical area serviced by the second basic service set 150. This roaming capability can allow the third notebook 160 to maintain a continuous data session while moving through the coverage area of the extended service set 130. As the third notebook 160 moves, it might detect that the target access point has switched and can use improved timing definitions to resume its traffic.

For example, the wireless local networking system 100 can be configured to implement concurrent clear channel assessments across different directional beams. The first access point 145 could identify the first notebook 141 and the second notebook 142 as target stations for data transmission. The first access point 145 might then direct separate radio frequency beams toward the first notebook 141 and the second notebook 142. By initiating concurrent countdowns for these different directions, the first access point 145 can efficiently manage wireless medium access without unnecessary delays.

For instance, the wireless local networking system 100 might utilize millimeter wave frequencies to provide high-throughput communication within the extended service set 130. The second access point 155 can employ multiple phased antenna arrays to focus energy toward specific devices like the first tablet 151 and the fourth notebook 152. This spatial reuse can allow the second access point 155 to isolate transmissions and reduce interference across the second basic service set 150. Consequently, devices located in different physical sectors can be serviced concurrently with highly directional beams.

In a non-limiting example, the third notebook 160 could be serviced by a targeted beam from the first access point 145 while roaming. If a data transmission to the first notebook 141 interferes with the clear channel assessment for the third notebook 160, the first access point 145 might pause the countdown associated with the third notebook 160. Once the transmission completes, the countdown can resume, allowing the third notebook 160 to receive its data efficiently. This precise management of overlapping transmissions can ensure robust connectivity across the wireless local networking system 100.

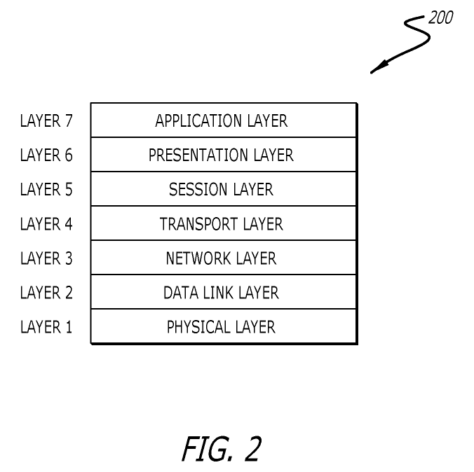

Although a specific embodiment for a wireless local networking system 100 for carrying out the various steps, processes, methods, and operations described herein is discussed with respect to FIG. 1, any of a variety of systems and/or devices may be utilized in accordance with embodiments of the disclosure. For example, the wireless local networking system 100 may be configured to include additional network controllers, mesh nodes, or alternative client devices to suit large-scale enterprise deployments. The elements depicted in FIG. 1 may also be interchangeable with other elements of FIGS. 2–19 as required to realize a particularly desired embodiment.

Referring to FIG. 2, a conceptual depiction of a communication layer architecture 200, in accordance with various embodiments of the disclosure is shown. In many embodiments, the communication layer architecture 200 can represent a theoretical model that might standardize the functions of a telecommunication or computing system into discrete layers. The communication layer architecture 200 can be configured to facilitate interoperability between diverse communication systems using standard protocols. By partitioning the communication process into smaller, manageable layers, the communication layer architecture 200 might ensure that changes in one layer do not require changes in other layers. Furthermore, the communication layer architecture 200 can serve as a conceptual framework to guide the design and troubleshooting of network protocols, such as those utilized in millimeter wave wireless local networking.

In various embodiments, the communication layer architecture 200 can include an application layer, which is often designated as Layer 7. The application layer can serve as the window for users and application processes to access network services. Often, the application layer might contain a variety of protocols that are commonly needed by users, such as those for file transfers, email, and web browsing. The application layer can interact directly with software applications that implement a communicating component. Such interactions at the application layer can initiate the data formatting and transmission processes that might subsequently flow down through the lower layers of the communication layer architecture 200.

In additional embodiments, the communication layer architecture 200 can comprise a presentation layer, which might be referred to as Layer 6. The presentation layer can be configured to format and translate data for the application layer based on the semantics and syntax that the application accepts. Often, the presentation layer might handle data encryption and decryption to secure communications before they are transmitted down the stack. The presentation layer can also perform data compression to reduce the number of bits that need to be transferred over the network. By ensuring that data is in a readable format, the presentation layer might enable seamless data exchange between different systems utilizing the communication layer architecture 200.

In further embodiments, the communication layer architecture 200 can feature a session layer, commonly known as Layer 5. The session layer can be responsible for establishing, managing, and terminating connections between local and remote applications. Often, the session layer might provide mechanisms for full-duplex, half-duplex, or simplex operation, and can establish checkpointing, adjournment, termination, and restart procedures. The session layer can ensure that data streams are properly synchronized and that communication sessions are maintained reliably over time. Through these management functions, the session layer might facilitate organized and structured dialogues between communicating entities within the communication layer architecture 200.

In some embodiments, the communication layer architecture 200 can encompass a transport layer, indicated as Layer 4. The transport layer can provide transparent transfer of data between end users, potentially providing reliable data transfer services to the upper layers. Often, the transport layer might control the reliability of a given link through flow control, segmentation and desegmentation, and error control. The transport layer can ensure that data packets are delivered error-free, in sequence, and with no losses or duplications. By managing end-to-end communication, the transport layer can serve as a critical bridge between the application-oriented upper layers and the network-oriented lower layers of the communication layer architecture 200.

In many embodiments, the communication layer architecture 200 can include a network layer, which is typically Layer 3. The network layer can be configured to provide the functional and procedural means of transferring variable length data sequences from a source host on one network to a destination host on a different network. Often, the network layer might perform network routing functions, and might also perform fragmentation and reassembly of data packets. The network layer can utilize logical addresses, such as internet protocol addresses, to identify devices and determine the most efficient path for data transmission. Through these routing capabilities, the network layer can ensure that data reaches its intended destination across complex, multi-node networks.

In certain embodiments, the communication layer architecture 200 can contain a data link layer, recognized as Layer 2. The data link layer can provide node-to-node data transfer and might handle error correction from the physical layer. Often, the data link layer can be divided into two sublayers that might dictate logical link control and media access control. The data link layer can manage how devices within the same local network share the communication medium, which is particularly relevant for clear channel assessments and medium access control. By framing data packets and controlling access to the physical medium, the data link layer can facilitate organized and reliable local data exchanges.

In numerous embodiments, the communication layer architecture 200 can rest upon a physical layer, designated as Layer 1. The physical layer can define the electrical and physical specifications of the data connection. Often, the physical layer might define the relationship between a device and a physical transmission medium, such as a copper or fiber optical cable, or a radio frequency link. The physical layer can encompass the layout of pins, voltages, line impedance, cable specifications, signal timing, and similar physical characteristics. In wireless networks, the physical layer can involve the radio transceivers, phased antenna arrays, and beamforming hardware that might transmit and receive raw bit streams over the air.

For example, the communication layer architecture 200 can provide a framework for implementing concurrent clear channel assessments within a millimeter wave network. A network device could operate at the application layer to queue video streaming data destined for multiple client devices. This data might traverse down through the presentation layer and session layer until it reaches the transport layer, where it can be segmented into manageable packets. The network layer can route these packets, and the data link layer might prepare them for transmission by organizing them into physical layer protocol data units. Subsequently, the physical layer could utilize multiple phased antenna arrays to direct separate radio frequency beams toward the respective target devices while performing concurrent clear channel assessments.

For instance, the communication layer architecture 200 might dictate how a client device handles backoff procedures during directional transmissions. At the data link layer, a concurrent clear channel assessment logic could determine that a radio frequency beam is directed toward an access point. If the physical layer detects interfering energy in that specific direction, the data link layer can initiate a random backoff countdown to delay transmission. The transport layer and network layer might buffer the outgoing data while the data link layer waits for the medium to clear. Once the physical layer indicates a clear channel, the data link layer can release the frames for transmission, potentially ensuring robust collision avoidance in a directional wireless environment.

In a non-limiting example, the interaction between layers of the communication layer architecture 200 can facilitate the accurate reception of control frames. The physical layer of a receiving device might detect an incoming directional transmission and pass the raw data bits up to the data link layer. The data link layer can process this physical layer protocol data unit to determine if an acknowledgment or response frame is required. If a response is needed, the data link layer can instruct the physical layer to transmit a directional response frame back to the source. Throughout this process, the upper layers of the communication layer architecture 200, such as the network layer and transport layer, might remain agnostic to these immediate link-level acknowledgments, allowing for efficient, modular handling of wireless communication protocols.

Although a specific embodiment for a communication layer architecture 200 for carrying out the various steps, processes, methods, and operations described herein is discussed with respect to FIG. 2, any of a variety of systems and/or devices may be utilized in accordance with embodiments of the disclosure. For example, the communication layer architecture 200 may be modified to compress certain layers or introduce sublayers specific to advanced wireless standards. Furthermore, alternative layer models might be substituted depending on the specific networking protocols being deployed within the environment. The elements depicted in FIG. 2 may also be interchangeable with other elements of FIGS. 1 and 3–19 as required to realize a particularly desired embodiment.

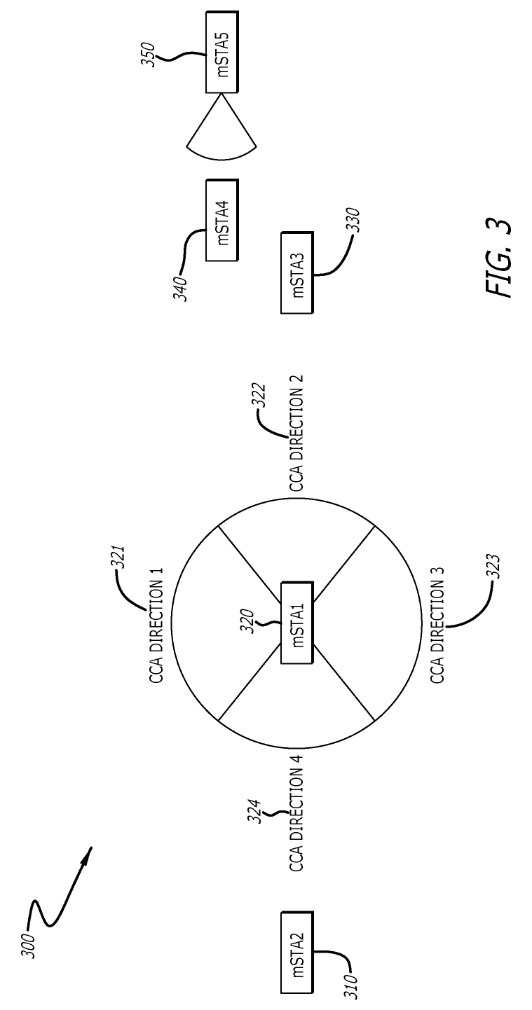

Referring to FIG. 3, a clear channel assessment diagram 300 illustrating clear channel assessment directions associated with a station in a wireless network, in accordance with various embodiments of the disclosure is shown. In many embodiments, the clear channel assessment diagram 300 can represent a spatial configuration of multiple stations communicating in a millimeter wave frequency band. As wireless networks transition to higher frequency spectrums, devices might rely on highly directional antennas to overcome propagation challenges. The clear channel assessment diagram 300 can illustrate how these directional antennas might influence the way a device assesses the wireless medium before attempting to transmit data.

In various embodiments, a first station 310 can be a central device evaluating its surrounding wireless medium. The first station 310 can be configured with one or more phased antenna arrays that might allow it to direct radio frequency energy in specific directions. Often, the first station 310 might attempt to establish a communication link with another nearby device, which could require it to first ensure the channel remains clear. By utilizing directional sensing, the first station 310 can potentially avoid unnecessary backoff procedures that might occur if it were using an omnidirectional sensing approach.

In numerous embodiments, a second station 320 can be positioned in a specific spatial relationship relative to the first station 310. The second station 320 might represent a neighboring device that could either be a potential target for communication or a source of interference. Often, the second station 320 can operate independently of the first station 310, potentially conducting its own data transmissions within the network. Depending on the direction of its transmissions, the second station 320 may or may not impact the clear channel assessments performed by the first station 310.

In some embodiments, a third station 330 can be another wireless device located within the operational range of the first station 310. The third station 330 can serve as an intended recipient for a physical layer protocol data unit queued at the first station 310. Often, the third station 330 might be positioned in a distinct spatial sector, which can compel the first station 310 to aim its radio frequency beam specifically toward the third station 330. By focusing its energy and assessment efforts toward the third station 330, the first station 310 can optimize its transmission efficiency.

In additional embodiments, a fourth station 340 can be present within the network environment, potentially located further away or in a slightly different trajectory. The fourth station 340 can engage in a separate communication session with other surrounding devices. Often, the fourth station 340 might act as a receiving device for transmissions originating from nearby nodes, which could inadvertently leak radio frequency energy into the surrounding area. The presence and activities of the fourth station 340 can introduce variables that other stations might need to account for during their medium access procedures.

In further embodiments, a fifth station 350 can be an active transmitter directing a radio frequency beam toward the fourth station 340. The fifth station 350 might generate significant radio frequency energy that could propagate across the shared wireless medium. Often, if the directional beam from the fifth station 350 aligns with the sensing direction of other devices, it can trigger a busy medium detection event. Consequently, the transmission from the fifth station 350 can cause neighboring nodes to update their network allocation vectors and pause their backoff countdowns.

In many embodiments, a first clear channel assessment direction 321 can represent a specific spatial sector that the first station 310 might monitor. The first clear channel assessment direction 321 can encompass a predefined angular range, such as a ninety-degree quadrant, although narrower or wider ranges might be utilized based on antenna capabilities. Often, the first station 310 can configure its antenna patterns to listen for incoming radio frequency energy strictly within the bounds of the first clear channel assessment direction 321. This focused listening can allow the first station 310 to ignore interference originating from completely unrelated angles across the network.

In certain embodiments, a second clear channel assessment direction 322 can delineate another spatial sector monitored by the first station 310. The second clear channel assessment direction 322 might orient toward the third station 330, which can make it a critical sector for the first station 310 when attempting to transmit data to that specific peer. Often, when the first station 310 intends to communicate with the third station 330, it might limit its channel sensing exclusively to the second clear channel assessment direction 322. By doing so, the first station 310 can potentially expedite its access to the medium if the second clear channel assessment direction 322 remains free of interfering signals.

In more embodiments, a third clear channel assessment direction 323 can be a further segmented area that the first station 310 may be capable of evaluating. The third clear channel assessment direction 323 might cover a spatial zone that currently lacks any target devices or active communication partners for the first station 310. Often, the first station 310 can utilize calibrated antenna patterns to ensure that energy from the third clear channel assessment direction 323 does not inadvertently bleed into its sensing operations for other sectors. This spatial isolation can be useful for maximizing the efficiency of millimeter wave networking architectures.

In still more embodiments, a fourth clear channel assessment direction 324 can represent the final spatial quadrant surrounding the first station 310. The fourth clear channel assessment direction 324 might point toward the second station 320, meaning any transmissions originating from the second station 320 could be detected if the first station 310 were actively monitoring this sector. Often, if the first station 310 is focused on transmitting in a completely opposite direction, it might disregard energy detected within the fourth clear channel assessment direction 324. This selective deafness can allow the first station 310 to proceed with its own transmissions despite nearby activity.

For example, the clear channel assessment diagram 300 can demonstrate a scenario where directional sensing might prevent unnecessary transmission delays. The first station 310 could prepare to send data to the third station 330, thereby requiring it to perform a clear channel assessment exclusively in the second clear channel assessment direction 322. Concurrently, the second station 320 might begin broadcasting a high-power signal that propagates through the fourth clear channel assessment direction 324. Because the first station 310 can restrict its sensing to the second clear channel assessment direction 322, it might completely ignore the interference from the second station 320, allowing it to complete its backoff countdown successfully.

In a non-limiting example, the clear channel assessment diagram 300 might also illustrate how overlapping directional beams can influence network allocation vectors. While the first station 310 evaluates the second clear channel assessment direction 322 to reach the third station 330, the fifth station 350 could initiate a transmission to the fourth station 340. The radio frequency energy from the fifth station 350 might travel through the second clear channel assessment direction 322 and be detected by the sensing antennas of the first station 310. Upon detecting this energy, the first station 310 might update its internal timers and pause any active backoff procedures until the medium within the second clear channel assessment direction 322 can be deemed clear again.

For instance, the configuration shown in the clear channel assessment diagram 300 can support advanced concurrent clear channel assessment techniques across multiple sectors. If the first station 310 had data queued for both the second station 320 and the third station 330, it might utilize independent reception paths to monitor both the fourth clear channel assessment direction 324 and the second clear channel assessment direction 322 simultaneously. If the medium remains clear in both directions, the first station 310 could count down separate backoff timers for each destination in parallel. Once a timer expires, the first station 310 might transmit the corresponding packet, potentially pausing the remaining timer if the transmission causes internal radio frequency interference.

Although a specific embodiment for a clear channel assessment diagram 300 for carrying out the various steps, processes, methods, and operations described herein is discussed with respect to FIG. 3, any of a variety of systems and/or devices may be utilized in accordance with embodiments of the disclosure. For example, the clear channel assessment diagram 300 may be configured to represent environments with a greater density of stations or employing overlapping clear channel assessment directions to achieve finer spatial resolution. The elements depicted in FIG. 3 may also be interchangeable with other elements of FIGS. 1–2 and 4-19 as required to realize a particularly desired embodiment.

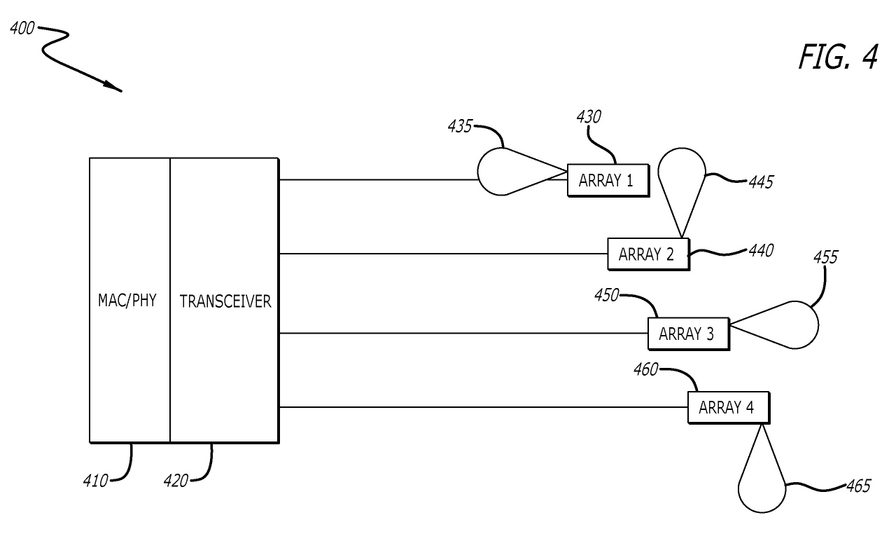

Referring to FIG. 4, a block diagram illustrating a transceiver with multiple phased antenna arrays, in accordance with various embodiments of the disclosure is shown. In many embodiments, a multi-path transceiver architecture 400 can represent a hardware configuration for a network device operating in millimeter wave frequency bands. The multi-path transceiver architecture 400 can be configured to support highly directional communication links with multiple target stations simultaneously or sequentially. By separating the radio frequency paths, the multi-path transceiver architecture 400 might allow a single access point to perform independent channel assessments and data transmissions in distinct spatial sectors. This hardware arrangement can form the foundation for concurrent clear channel assessment techniques that reduce latency and improve spatial reuse across the network.

In a number of embodiments, a medium access control and physical layer 410 can act as the digital processing core of the multi-path transceiver architecture 400. The medium access control and physical layer 410 might be configured to queue incoming protocol data units and determine their respective destinations within the wireless network. Often, the medium access control and physical layer 410 can manage independent backoff counters for multiple queued transmissions destined for different spatial sectors. The medium access control and physical layer 410 can also process incoming data streams and coordinate the timing of response frames based on the specific constraints of the wireless standard.

In more embodiments, a transceiver 420 can be communicatively coupled to the medium access control and physical layer 410 to convert digital signals into analog radio frequency energy. The transceiver 420 might include multiple independent transmit and receive paths that can be operated concurrently. Often, the transceiver 420 can route specific data streams to distinct antenna arrays based on instructions from the medium access control and physical layer 410. The transceiver 420 can be configured with sufficient internal isolation to prevent high-power transmissions on one path from overwhelming sensitive reception operations on an adjacent path.

In further embodiments, a first array 430 can be connected to a first dedicated path of the transceiver 420. The first array 430 might comprise a plurality of individual antenna elements coupled with phase shifters. Often, the first array 430 can dynamically adjust the phase and amplitude of signals to steer radio frequency energy electronically without physical movement. The first array 430 can be utilized to both transmit data packets to a targeted client device and perform directional listening during a clear channel assessment.

In some embodiments, a first beam 435 can represent the concentrated electromagnetic energy emitted or received by the first array 430. The first beam 435 might be characterized by a specific electrical beam angle and a narrow beamwidth that enhances signal strength over a limited spatial area. Often, the first beam 435 can be pointed toward a specific client device located in a corresponding sector of the network environment. By maintaining a narrow profile, the first beam 435 can minimize interference caused to or received from other devices outside of its direct trajectory.

In additional embodiments, a second array 440 can be a phased antenna array driven by a second independent path of the transceiver 420. The second array 440 can operate concurrently with the first array 430 to service a completely different geographic sector. Like other arrays in the system, the second array 440 might utilize analog beamforming to overcome the high path loss associated with millimeter wave frequencies. The second array 440 can be assigned to monitor a specific direction for incoming transmissions or to conduct a secondary clear channel assessment while other paths are occupied.

In many embodiments, a second beam 445 can be the resulting radiation pattern produced by the second array 440. The second beam 445 might be steered to target a different client device than the first beam 435, providing spatial separation. Often, the effectiveness of concurrent channel assessments can depend on the radio frequency isolation between the second beam 445 and other active beams in the system. The second beam 445 can be configured to remain active for receiving block acknowledgments even after its associated data transmission has concluded.

In various embodiments, a third array 450 can provide a third spatial degree of freedom for the transceiver 420. The third array 450 might be directed toward another distinct portion of the coverage area to communicate with yet another station. Often, the third array 450 can be integrated into a round-robin allocation scheme when multiple queued transmissions require service. The third array 450 can assist in maximizing the spatial reuse capabilities of the multi-path transceiver architecture 400 by adding another independent transmission or reception vector.

In still more embodiments, a third beam 455 can be shaped and steered by the phase configurations applied to the third array 450. The third beam 455 might carry control frames, data payloads, or sensing operations independently of the other beams. Often, the third beam 455 can be oriented such that its side lobes do not significantly interfere with the main lobes of adjacent beams. The third beam 455 can be dynamically reconfigured between transmit and receive modes to accommodate the immediate traffic demands of its targeted station.

In numerous embodiments, a fourth array 460 can represent a fourth set of antenna elements connected to a final path of the transceiver 420. The fourth array 460 might allow the multi-path transceiver architecture 400 to achieve broad, multi-sector coverage simultaneously. Like the preceding arrays, the fourth array 460 can perform its own distinct clear channel assessment in its assigned direction. The fourth array 460 can be utilized to listen for initial control frames or responses from devices entering its operational quadrant.

In certain embodiments, a fourth beam 465 can define the spatial reach of the fourth array 460. The fourth beam 465 might be directed downward or at an extreme angle compared to the other beams to service differently positioned devices. Often, the fourth beam 465 can be rapidly switched to a new angle if a mobile client device moves out of its initial boresight. The precise shaping of the fourth beam 465 can ensure that the overall multi-path transceiver architecture 400 maintains high data throughput across a densely populated wireless environment.

For example, the multi-path transceiver architecture 400 can be utilized to manage concurrent backoff counters for multiple queued packets. The medium access control and physical layer 410 could queue a first packet for a device in the direction of the first beam 435 and a second packet for a device in the direction of the second beam 445. The transceiver 420 might activate the first array 430 and the second array 440 to independently sense the wireless medium in their respective directions. If both directions are clear, the medium access control and physical layer 410 can count down two separate backoff timers simultaneously, significantly reducing the wait time before transmission.

For instance, the multi-path transceiver architecture 400 might need to pause a clear channel assessment if internal isolation is insufficient. The first array 430 could begin transmitting data over the first beam 435 while the third array 450 is actively performing a clear channel assessment utilizing the third beam 455. If the transmission from the transceiver 420 leaks into the receive path of the third array 450, it might register as a busy medium. In response, the medium access control and physical layer 410 can temporarily pause the backoff counter associated with the third beam 455 until the transmission over the first beam 435 is fully completed.

In a non-limiting example, the multi-path transceiver architecture 400 can dynamically reallocate its resources when an active transmission concludes. Once the medium access control and physical layer 410 finishes a data transfer via the transceiver 420 and the fourth array 460, the fourth beam 465 might become free. If there is a new queued transmission for a client in the sector covered by the second array 440, but the second array 440 is already occupied, the medium access control and physical layer 410 could reassign the fourth array 460 to point the fourth beam 465 into that sector. This flexible assignment can allow the multi-path transceiver architecture 400 to continuously optimize its clear channel assessments and data delivery based on real-time network demands.

Although a specific embodiment for a multi-path transceiver architecture 400 for carrying out the various steps, processes, methods, and operations described herein is discussed with respect to FIG. 4, any of a variety of systems and/or devices may be utilized in accordance with embodiments of the disclosure. For example, the multi-path transceiver architecture 400 might include more or fewer than four arrays, or might employ digital beamforming in conjunction with analog phase shifters. The elements depicted in FIG. 4 may also be interchangeable with other elements of FIGS. 1–3 and 5-19 as required to realize a particularly desired embodiment.

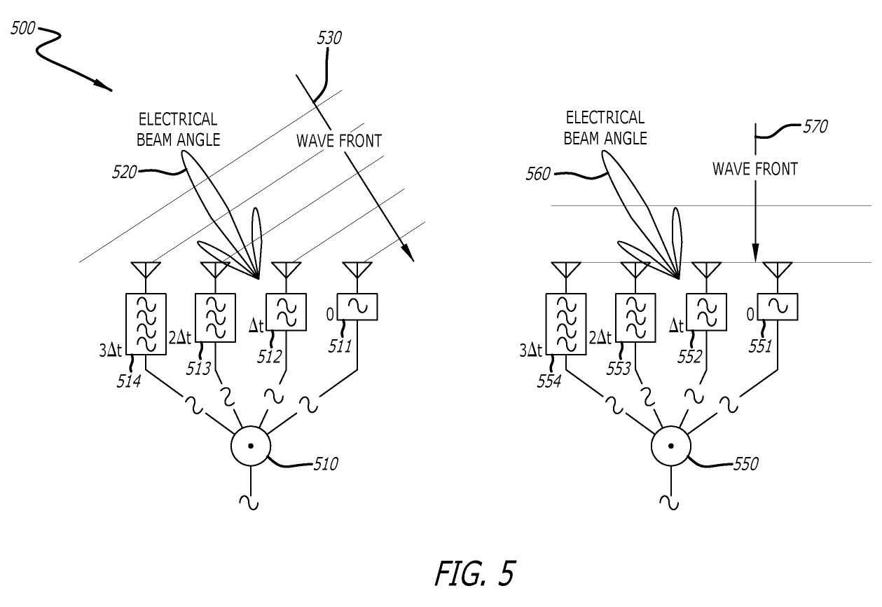

Referring to FIG. 5, a phased array antenna diagram 500, in accordance with various embodiments of the disclosure is shown. In many embodiments, the phased array antenna diagram 500 can illustrate how radio frequency signals are combined and delayed to achieve directional beamforming. As wireless networks expand into millimeter wave frequencies, managing the precise timing of signals across multiple antenna elements can become increasingly important. The phased array antenna diagram 500 can demonstrate the physical layer mechanisms that might support the concurrent clear channel assessments and targeted data transmissions described herein. By adjusting the phase and delay of the incoming or outgoing signals, a device can potentially focus its energy into specific spatial sectors while ignoring interference from others.

In various embodiments, a first combiner 510 can act as a central junction for radio frequency signals entering or leaving an antenna array. The first combiner 510 might split an outgoing signal from a medium access control layer into multiple separate paths for transmission. Conversely, during a receive operation or clear channel assessment, the first combiner 510 can merge incoming signals that were received across a plurality of individual antenna elements. Often, the first combiner 510 can be integrated directly within the transceiver architecture to ensure minimal signal loss. This integration can allow the first combiner 510 to efficiently funnel radio frequency energy to and from the associated antenna arrays.

In some embodiments, a first zero delay block 511 can be connected to one of the paths branching from the first combiner 510. The first zero delay block 511 might represent a baseline phase state where no intentional delay or phase shift is applied to the signal passing through it. Often, the first zero delay block 511 can serve as a reference point for the other elements within the phased antenna array. The signal traveling through the first zero delay block 511 can arrive at its corresponding antenna element without any artificial timing modification. In many instances, the first zero delay block 511 can be utilized to anchor the timing calculations required to steer the resulting beam accurately.

In further embodiments, a first single delay block 512 can be positioned on an adjacent signal path relative to the first zero delay block 511. The first single delay block 512 can be configured to apply a specific time delay, often denoted as a single delta increment, to the radio frequency signal. This precise delay introduced by the first single delay block 512 might alter the phase of the signal just before it reaches the antenna element. By systematically applying this timing offset, the first single delay block 512 can contribute to the creation of a focused wavefront. Often, the first single delay block 512 can be dynamically adjusted by the network device to steer the beam in real time as client devices move.

In additional embodiments, a first double delay block 513 can be incorporated into the antenna array structure to further manipulate the signal timing. The first double delay block 513 might apply a delay that is twice the magnitude of the delay applied by the first single delay block 512. Often, the first double delay block 513 can operate in concert with the other delay elements to build a cumulative phase progression across the entire antenna array. This progressive delay created by the first double delay block 513 can dictate the exact angle at which the electromagnetic waves constructively interfere. The first double delay block 513 can be essential for achieving the narrow beamwidths required for high-frequency millimeter wave communications.

In still more embodiments, a first triple delay block 514 can be connected to a terminal path of the array originating from the first combiner 510. The first triple delay block 514 can apply the maximum relative delay in this specific sequence, which might be three times the base delay value. By shifting the signal to this extent, the first triple delay block 514 can ensure that the wave emitted or received by its associated antenna element aligns perfectly with the waves from the other elements. Often, the first triple delay block 514 can help maximize the gain of the antenna array in a desired spatial direction. The precise calibration of the first triple delay block 514 can prevent unwanted signal leakage into adjacent spatial sectors.

In many embodiments, a first electrical beam angle 520 can represent the resulting trajectory of the radio frequency energy after passing through the various delay blocks. The first electrical beam angle 520 might indicate a directional focus relative to the antenna array plane. Often, the first electrical beam angle 520 can be calculated and established to target a specific client device for data transmission or clear channel assessment. The first electrical beam angle 520 can allow the network device to restrict its listening or transmitting operations to a narrow spatial corridor. By maintaining a strict first electrical beam angle 520, the system can potentially execute concurrent operations across different sectors without mutual interference.

In certain embodiments, a first wave front 530 can illustrate the physical manifestation of the electromagnetic waves propagating through space. The first wave front 530 might demonstrate how signals delayed to match the time of arrival at each element are perfectly in phase at the point of combining. Often, the alignment of the first wave front 530 can indicate that the antenna array is properly tuned to receive or transmit energy along the first electrical beam angle 520. When an incoming signal matches the orientation of the first wave front 530, the elements can capture the energy synchronously. This synchronous capture associated with the first wave front 530 can yield a strong signal at the first combiner 510, which might accurately trigger a busy assessment during a channel check.

In various embodiments, a second combiner 550 can represent a similar signal junction utilized in a different operational context or by a different antenna array path. The second combiner 550 might manage signals for a secondary clear channel assessment occurring concurrently with operations on the first combiner 510. Often, the second combiner 550 can route signals to an independent set of delay blocks to evaluate a distinct spatial sector. The second combiner 550 can ensure that the energy received from its respective antenna elements is aggregated before being processed by the physical layer. This independent aggregation at the second combiner 550 can facilitate the parallel execution of multiple backoff countdowns.

In numerous embodiments, a second zero delay block 551 can be coupled to the second combiner 550 to establish a timing baseline for this secondary array configuration. The second zero delay block 551 might allow a portion of the radio frequency signal to pass through to its antenna element without any phase adjustment. Often, the second zero delay block 551 can function identically to its counterpart in the first array, potentially providing a consistent reference for beam steering. The unshifted signal from the second zero delay block 551 can interact with shifted signals from adjacent elements to shape the overall beam pattern. In many configurations, the second zero delay block 551 can be hardwired or digitally configured to maintain a strict zero-delay state.

In some embodiments, a second single delay block 552 can introduce a predefined timing offset into the signal path adjoining the second zero delay block 551. The second single delay block 552 might be tuned to apply the same delta time delay to maintain a specific electrical beam angle. Often, the second single delay block 552 can be reprogrammed rapidly between data transmission and clear channel assessment phases to scan different areas. The precise timing control provided by the second single delay block 552 can be critical for suppressing interference from unwanted directions. The second single delay block 552 can ensure that incoming signals from non-targeted angles destructively interfere.

In additional embodiments, a second double delay block 553 can further shift the phase of the signal within the secondary array structure. The second double delay block 553 might apply a delay that amplifies the steering effect initiated by the preceding blocks. Often, the second double delay block 553 can contribute to the creation of a highly directional listening cone during a clear channel assessment. This directional cone, supported by the second double delay block 553, can allow the network device to ignore high-power transmissions occurring in adjacent sectors. The second double delay block 553 can be a vital component for enabling the dense spatial reuse characteristic of millimeter wave networks.

In further embodiments, a second triple delay block 554 can provide the most extreme phase shift within this particular four-element array configuration. The second triple delay block 554 might complete the phase gradient required to tilt the beam to its intended trajectory. Often, the second triple delay block 554 can be calibrated to account for any minor physical discrepancies in the antenna manufacturing process. The signal exiting or entering the second triple delay block 554 can complete the constructive interference pattern necessary for high-throughput data transfer. The second triple delay block 554 can work in unison with the other blocks to form a cohesive, steerable radio frequency beam.

In many embodiments, a second electrical beam angle 560 can dictate the spatial orientation of the beam formed by the secondary array components. The second electrical beam angle 560 might be set to the exact same tilt as the first array, but in this context, it can illustrate a mismatch with an incoming signal. Often, the second electrical beam angle 560 can represent the direction the device is currently listening for a clear channel assessment. The second electrical beam angle 560 can be rigidly maintained while the medium access control layer counts down its random backoff timer. By keeping the second electrical beam angle 560 constant, the device can potentially guarantee that the targeted sector is truly clear before transmitting.

In certain embodiments, a second wave front 570 can represent an incoming radio frequency signal that originates from a direction differing from the steered beam. The second wave front 570 might arrive perpendicularly to the antenna elements, meaning its signals are delayed differently than the time of arrival at each element. Often, because the incoming second wave front 570 does not match the configured delays, the signals are no longer in phase at the point of combining. This phase mismatch caused by the second wave front 570 can result in destructive interference at the second combiner 550, effectively nullifying the signal. Consequently, the second wave front 570 can be ignored by the clear channel assessment logic, allowing the backoff countdown to continue uninterrupted.

For example, the components illustrated in the phased array antenna diagram 500 can be utilized to isolate a clear channel assessment from nearby interference. A network device could configure the first zero delay block 511, the first single delay block 512, the first double delay block 513, and the first triple delay block 514 to establish the first electrical beam angle 520. While the device listens along this first electrical beam angle 520, an interfering transmission might arrive as the second wave front 570 from a completely different direction. Because the incoming second wave front 570 does not align with the programmed phase delays, it might destructively interfere at the first combiner 510 and fail to trigger a busy medium alert. This rejection of the second wave front 570 can allow the network device to successfully complete its clear channel assessment and transmit its data without unnecessary delay.

For instance, the phased array antenna diagram 500 might demonstrate how a system can evaluate two different spatial sectors concurrently. An access point can utilize the first combiner 510 and its associated delay blocks to monitor a first target station at the first electrical beam angle 520. Simultaneously, the access point could employ the second combiner 550 and its respective delay blocks to establish the second electrical beam angle 560 aimed at a second target station. If a strong signal arrives perfectly aligned with the first wave front 530, the first combiner 510 can detect the energy and pause the first backoff counter. However, if that same signal arrives off-axis relative to the second electrical beam angle 560, it might be filtered out, allowing the second backoff counter to proceed independently.

In a non-limiting example, the physical layer components in the phased array antenna diagram 500 can facilitate rapid beam switching following a data transmission. After completing a transmission using the first electrical beam angle 520, the network device might quickly reconfigure the first single delay block 512, the first double delay block 513, and the first triple delay block 514 to point toward a new client. This rapid reconfiguration can establish a new listening direction to capture an incoming first wave front 530 from the new client during a subsequent clear channel assessment. By leveraging these electronic phase shifters rather than physical movements, the network device can minimize the gap between consecutive transmission opportunities. The ability to dynamically adjust the first wave front 530 capture angle can be critical for maintaining high throughput in dense millimeter wave environments.

Although a specific embodiment for a phased array antenna diagram 500 for carrying out the various steps, processes, methods, and operations described herein is discussed with respect to FIG. 5, any of a variety of systems and/or devices may be utilized in accordance with embodiments of the disclosure. For example, the phased array antenna diagram 500 may be expanded to include arrays with dozens or hundreds of elements, rather than just four, to achieve even narrower beamwidths. Furthermore, digital beamforming techniques might be combined with these analog phase shifters to create hybrid architectures capable of processing multiple spatial streams simultaneously. The elements depicted in FIG. 5 may also be interchangeable with other elements of FIGS. 1–4 and 6-19 as required to realize a particularly desired embodiment.

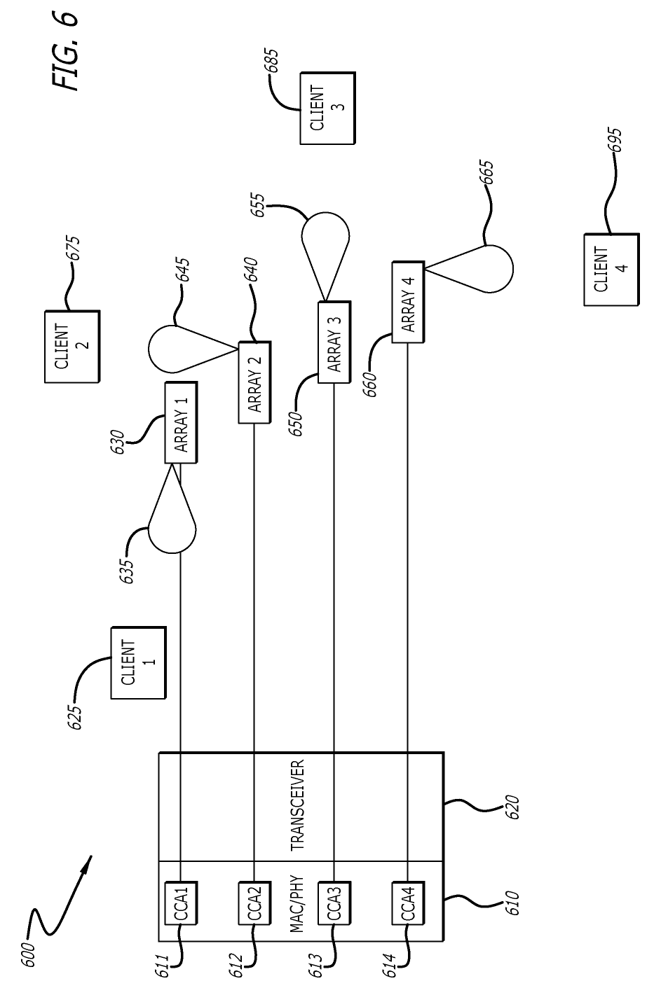

Referring to FIG. 6, a concurrent clear channel assessment architecture 600, in accordance with various embodiments of the disclosure is shown. In many embodiments, the concurrent clear channel assessment architecture 600 can represent an access point or network device configured to handle multiple millimeter wave links. The concurrent clear channel assessment architecture 600 can utilize spatial reuse to communicate with multiple devices located in different directions simultaneously. By leveraging this spatial separation, the concurrent clear channel assessment architecture 600 might perform independent medium sensing operations without causing internal delays.

In numerous embodiments, a first clear channel assessment logic 611 can be an independent counter dedicated to a specific receive path. The first clear channel assessment logic 611 might initiate a backoff countdown when a data packet is queued for a particular targeted device. Often, the first clear channel assessment logic 611 can monitor the energy levels strictly from a designated spatial sector. If interfering energy is detected within that sector, the first clear channel assessment logic 611 can temporarily suspend its countdown to avoid a collision.

In various embodiments, a second clear channel assessment logic 612 can be a second independent counter associated with another receive path. The second clear channel assessment logic 612 can operate concurrently with other sensing mechanisms within the device. Often, the second clear channel assessment logic 612 might evaluate a separate spatial sector, allowing it to progress its backoff counter independently of activity in other sectors. The second clear channel assessment logic 612 can ensure that transmission opportunities are seized efficiently for its respective target.

In certain embodiments, a third clear channel assessment logic 613 can provide a third independent backoff counter for the system. The third clear channel assessment logic 613 might be assigned to monitor a completely different geographic direction. Like its counterparts, the third clear channel assessment logic 613 can pause or resume its timer based solely on the radio frequency energy arriving from its specific target sector. The third clear channel assessment logic 613 can facilitate high-throughput communication by reducing the wait times associated with omnidirectional sensing.

In some embodiments, a fourth clear channel assessment logic 614 can represent a final independent sensing counter in a four-path configuration. The fourth clear channel assessment logic 614 can be utilized to evaluate channel conditions for a fourth spatially distinct target. Often, the fourth clear channel assessment logic 614 can operate simultaneously with the other logic blocks, provided there is adequate isolation between paths. The fourth clear channel assessment logic 614 can empower the network device to handle dense traffic loads by capitalizing on parallel processing capabilities.

In additional embodiments, a medium access control and physical layer 610 can encompass the various logic blocks and manage the overall digital processing. The medium access control and physical layer 610 might receive incoming data units and assign them to the appropriate independent paths. Often, the medium access control and physical layer 610 can coordinate the timing of transmissions to ensure that active transmissions do not inadvertently disrupt concurrent channel assessments. The medium access control and physical layer 610 can serve as the orchestrator for maintaining seamless millimeter wave communications.

In further embodiments, a transceiver 620 can be connected to the medium access control and physical layer 610 to handle the analog radio frequency conversions. The transceiver 620 might possess multiple isolated paths that correspond directly to the independent logic counters. Often, the transceiver 620 can amplify outgoing signals and filter incoming signals to maintain high fidelity. The internal isolation within the transceiver 620 can be critical to preventing a transmission on one path from bleeding over and interfering with an assessment on another path.

In many embodiments, a first client 625 can represent a target station located in a specific direction relative to the access point. The first client 625 might have data queued for it within the medium access control and physical layer 610. Often, the first client 625 can be positioned such that it can establish a strong millimeter wave link with the transmitting device. The first client 625 can participate in the network by sending necessary response frames after receiving its intended data.

In still more embodiments, a first array 630 can be a phased antenna array driven by the transceiver 620. The first array 630 can apply analog phase shifts to steer radio frequency energy electronically. Often, the first array 630 might be assigned to service the first client 625 exclusively during a particular transmission opportunity. The first array 630 can act as the physical interface for conducting the directional listening associated with the first clear channel assessment logic 611.

In numerous embodiments, a first beam 635 can be the focused electromagnetic wave generated by the first array 630. The first beam 635 might possess a narrow spatial profile tailored to reach the first client 625 while minimizing lateral interference. Often, the first beam 635 can be maintained during both the clear channel assessment phase and the subsequent data transmission phase. By concentrating energy within the first beam 635, the system can potentially achieve robust signal-to-noise ratios over limited distances.

In certain embodiments, a second array 640 can be another distinct set of antenna elements managed by the transceiver 620. The second array 640 might be dynamically configured to point in a completely different direction from the first array 630. Often, the second array 640 can conduct sensing operations dictated by the second clear channel assessment logic 612. The second array 640 can support the parallel processing goals of the architecture by handling a separate spatial sector simultaneously.

In some embodiments, a second beam 645 can represent the radiation pattern emitted or received by the second array 640. The second beam 645 can be electronically steered to target a device residing in a different location. Often, the spatial separation between the first beam 635 and the second beam 645 can provide the necessary radio frequency isolation for concurrent backoff countdowns. The precise control of the second beam 645 might prevent unintended energy from triggering busy signals on adjacent paths.

In additional embodiments, a second client 675 can be a wireless device situated in the path of the second beam 645. The second client 675 might be awaiting a pending data transmission queued within the medium access control and physical layer 610. Often, the second client 675 can be completely independent of the first client 625 and unaware of the concurrent operations occurring at the access point. The second client 675 can receive its data rapidly due to the parallel assessment capabilities of the network device.

In further embodiments, a third array 650 can provide a third independent antenna resource for the system. The third array 650 might be directed toward yet another spatial sector to expand the concurrent servicing capabilities. Like the other arrays, the third array 650 can operate under the control of the third clear channel assessment logic 613. The third array 650 can enhance the overall throughput of the access point by maintaining active links in diverse directions.

In many embodiments, a third beam 655 can define the focused energy corridor associated with the third array 650. The third beam 655 can be oriented to avoid overlap with the other active beams generated by the transceiver 620. Often, the structural characteristics of the third beam 655 might be adjusted dynamically based on feedback from the targeted device. The third beam 655 can ensure that energy is delivered precisely where it is needed without polluting the shared wireless medium.

In still more embodiments, a third client 685 can be the intended recipient for the data traversing the third beam 655. The third client 685 might establish a high-frequency link to receive information from the access point. Often, the third client 685 can transmit uplink data or control frames back along the same trajectory. The third client 685 can benefit from the reduced latency offered by the parallel backoff procedures executed at the access point.

In numerous embodiments, a fourth array 660 can be a final phased antenna group depicted in this configuration. The fourth array 660 can be coupled to the fourth clear channel assessment logic 614 via the transceiver 620. Often, the fourth array 660 can cover any remaining spatial sectors that require service within the coverage area. The fourth array 660 might allow the access point to maintain a comprehensive awareness through multiple simultaneous directional assessments.

In certain embodiments, a fourth beam 665 can represent the specific radiation pattern of the fourth array 660. The fourth beam 665 can be steered electronically to track moving targets or address new transmission queues. Often, the fourth beam 665 might be utilized to listen for incoming signals from devices that are not currently engaged in active data transfer. The flexibility of the fourth beam 665 can contribute to the highly adaptive nature of the network device.

In some embodiments, a fourth client 695 can be a wireless node located within the trajectory of the fourth beam 665. The fourth client 695 might represent a device requiring urgent data delivery or periodic synchronization. Often, the fourth client 695 can be serviced promptly because its associated clear channel assessment can run concurrently with others. The fourth client 695 can interact with the access point without being delayed by the traffic designated for the other three clients in the system.

For example, the concurrent clear channel assessment architecture 600 can be configured to manage multiple data queues efficiently. The medium access control and physical layer 610 could identify that data is queued for the first client 625, the second client 675, and the third client 685 simultaneously. In response, the transceiver 620 might activate the first array 630, the second array 640, and the third array 650 to generate the first beam 635, the second beam 645, and the third beam 655, respectively. The first clear channel assessment logic 611, the second clear channel assessment logic 612, and the third clear channel assessment logic 613 can then begin their independent backoff countdowns concurrently, potentially accelerating medium access for all three target devices.

For instance, the concurrent clear channel assessment architecture 600 might need to handle a scenario where internal interference affects some paths but not others. If the countdown within the first clear channel assessment logic 611 expires first, the transceiver 620 can begin transmitting data to the first client 625 using the first beam 635. During this transmission, the medium access control and physical layer 610 might determine that the transmission causes interference that desensitizes the fourth clear channel assessment logic 614. Consequently, the countdown for the fourth clear channel assessment logic 614 might be paused, while the countdowns for the second clear channel assessment logic 612 and the third clear channel assessment logic 613 might continue if they possess sufficient isolation.

In a non-limiting example, the concurrent clear channel assessment architecture 600 can be utilized to rapidly switch roles for a specific antenna array following a transmission. Once the data transmission to the second client 675 via the second beam 645 concludes, the second clear channel assessment logic 612 might become available. If new data is queued for the fourth client 695 and the fourth clear channel assessment logic 614 is currently blocked or unavailable, the medium access control and physical layer 610 might reassign the second array 640 to point toward the fourth client 695. The second clear channel assessment logic 612 could then immediately begin a new clear channel assessment for the fourth client 695, demonstrating the flexible and dynamic nature of the architecture.

Although a specific embodiment for a concurrent clear channel assessment architecture 600 for carrying out the various steps, processes, methods, and operations described herein is discussed with respect to FIG. 6, any of a variety of systems and/or devices may be utilized in accordance with embodiments of the disclosure. For example, the concurrent clear channel assessment architecture 600 might include dozens of parallel clear channel assessment logic blocks to support massive multiple-input multiple-output systems in dense enterprise environments. The elements depicted in FIG. 6 may also be interchangeable with other elements of FIGS. 1–5 and 7-19 as required to realize a particularly desired embodiment. Furthermore, the logic blocks and arrays can be implemented as either discrete hardware components or integrated modules within a single silicon die.

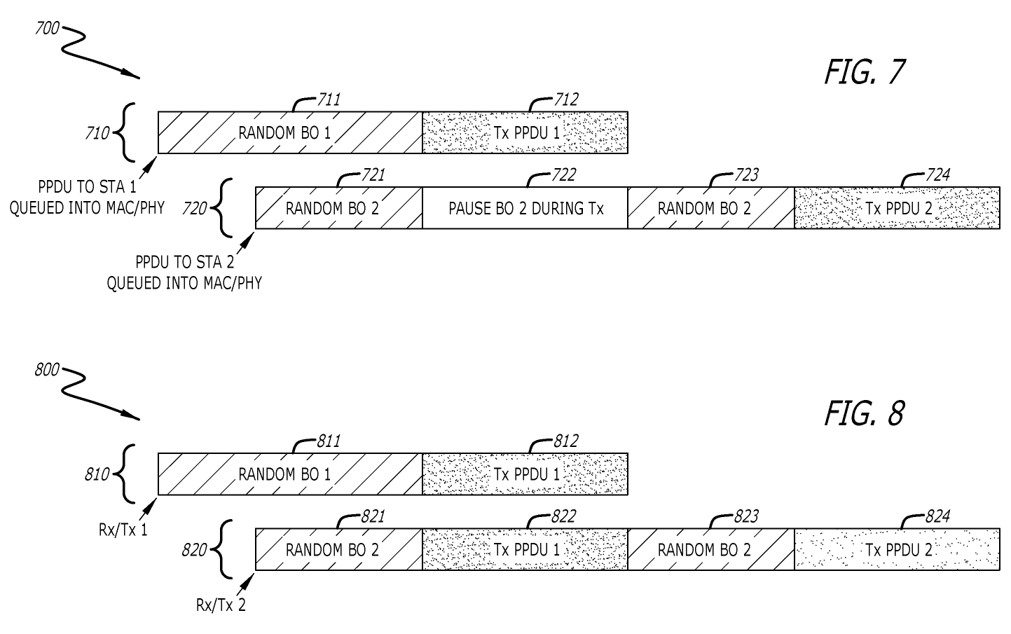

Referring to FIG. 7, a concurrent clear channel assessment timing diagram 700, in accordance with various embodiments of the disclosure is shown. In many embodiments, the concurrent clear channel assessment timing diagram 700 can illustrate how an access point manages overlapping backoff procedures for different target stations. As wireless networks utilize highly directional millimeter wave beams, devices might be able to assess multiple spatial sectors simultaneously. The concurrent clear channel assessment timing diagram 700 can demonstrate a scenario where physical layer protocol data units arrive in a medium access control queue at different times.

In various embodiments, a first timing path 710 can represent the sequence of events associated with a first queued transmission. The first timing path 710 might correspond to a specific phased antenna array directed toward a first non-access point station. Often, the operations depicted along the first timing path 710 can begin as soon as the corresponding data is queued into the medium access control and physical layer. The first timing path 710 can operate independently of other active paths until an internal hardware limitation or interference event occurs.

In a number of embodiments, a first random backoff period 711 can be initiated along the first timing path 710. The first random backoff period 711 might involve a counter counting down while the device listens for radio frequency energy in a specific direction. Often, the duration of the first random backoff period 711 can be determined by standard medium access collision avoidance rules. If the targeted spatial sector remains clear of interfering signals, the countdown within the first random backoff period 711 can reach zero without interruption.

In further embodiments, a first data transmission period 712 can commence immediately following the successful completion of the first random backoff period 711. The first data transmission period 712 might represent the active sending of a physical layer protocol data unit to the first targeted station. Often, the radio frequency energy emitted during the first data transmission period 712 can be highly directional. Depending on the internal isolation of the transmitting device, the activity during the first data transmission period 712 might inadvertently leak into other receiving paths within the same hardware.

In some embodiments, a second timing path 720 can run parallel to the first timing path 710. The second timing path 720 might represent a concurrent clear channel assessment effort directed toward a completely different target station. Often, the operations along the second timing path 720 can be triggered when a second physical layer protocol data unit enters the hardware queue at a slightly later time. The second timing path 720 can leverage a separate phased antenna array to ensure the sensing operations are spatially isolated from the first path.

In additional embodiments, an initial second random backoff period 721 can start along the second timing path 720 while the first path is still assessing the medium. The initial second random backoff period 721 might partially overlap in time with the sensing operations of the first path. Often, the initial second random backoff period 721 can progress successfully as long as its corresponding spatial sector is free of external interference. This overlapping countdown during the initial second random backoff period 721 can be a primary mechanism for reducing overall latency in dense networking environments.

In many embodiments, a paused backoff period 722 can interrupt the progress of the secondary countdown. The paused backoff period 722 might be triggered because the receiving hardware becomes desensitized during the active transmission occurring on the primary path. Often, the paused backoff period 722 can align perfectly with the duration of the interfering transmission. During the paused backoff period 722, the secondary antenna array might even be redirected to join in the active transmission toward the first client, temporarily abandoning its independent sensing role.

In still more embodiments, a resumed second random backoff period 723 can commence as soon as the internal interference subsides. The resumed second random backoff period 723 might pick up the countdown from the exact value it held prior to the interruption. Often, the resumed second random backoff period 723 can require the secondary antenna array to be steered back toward the second targeted station to verify the medium is still clear. Once the resumed second random backoff period 723 successfully reaches zero, the device can be authorized to send its queued data.

In numerous embodiments, a second data transmission period 724 can finalize the sequence along the secondary path. The second data transmission period 724 might involve sending a second physical layer protocol data unit to the second target station. Often, the second data transmission period 724 can occur significantly sooner than if the device had waited for the first transmission to finish entirely before even starting a backoff. The second data transmission period 724 can utilize the secondary antenna array exclusively, focusing radio frequency energy precisely where needed.

For example, the concurrent clear channel assessment timing diagram 700 can demonstrate how a network access point schedules data for two distinct clients. The access point might receive a first packet, triggering the first random backoff period 711 along the first timing path 710. Shortly thereafter, a second packet could be queued, prompting the initial second random backoff period 721 along the second timing path 720. If the first countdown finishes and initiates the first data transmission period 712, the resulting radio frequency leakage might desensitize the secondary receiver, necessitating the paused backoff period 722 to ensure compliance with collision avoidance rules.

For instance, the interactions within the concurrent clear channel assessment timing diagram 700 might be optimized if the transmitting device possesses superior internal isolation. If the hardware can completely shield the second timing path 720 from the energy emitted during the first data transmission period 712, the device might bypass the paused backoff period 722 entirely. In such a scenario, the initial second random backoff period 721 and the resumed second random backoff period 723 could merge into a single, continuous countdown. This continuous countdown would allow the second data transmission period 724 to begin even earlier, maximizing the data throughput of the millimeter wave node.

In a non-limiting example, the concurrent clear channel assessment timing diagram 700 can illustrate a scenario involving dynamic beam reallocation. During the paused backoff period 722, the secondary antenna array originally used for the second timing path 720 might temporarily change its phase configuration to point toward the first target station. By joining the primary antenna array, it could assist in the first data transmission period 712 to improve signal quality. Once the first transmission concludes, the secondary array can revert to its original orientation, allowing the resumed second random backoff period 723 to complete its assessment and advance to the second data transmission period 724.

Although a specific embodiment for a concurrent clear channel assessment timing diagram 700 for carrying out the various steps, processes, methods, and operations described herein is discussed with respect to FIG. 7, any of a variety of systems and/or devices may be utilized in accordance with embodiments of the disclosure. For example, the concurrent clear channel assessment timing diagram 700 may be extended to depict three or four parallel timing paths, each managing its own distinct backoff and pause parameters. Furthermore, the duration of the backoff periods can be adjusted dynamically based on prevailing network traffic conditions. The elements depicted in FIG. 7 may also be interchangeable with other elements of FIGS. 1–6 and 8-19 as required to realize a particularly desired embodiment.

Referring to FIG. 8, a path-specific operations timing diagram 800, in accordance with various embodiments of the disclosure is shown. In many embodiments, the path-specific operations timing diagram 800 can illustrate how individual receive and transmit paths within a network device handle concurrent channel assessments and dynamic beam shifting. As access points utilize highly directional millimeter wave beams, specific hardware paths might be capable of changing their focus to assist with active transmissions. The path-specific operations timing diagram 800 can demonstrate a scenario where a secondary radio frequency path temporarily abandons its own countdown to participate in a primary data transmission. This dynamic reallocation of antenna resources can optimize signal strength while still reducing the overall wait time for queued packets.

In numerous embodiments, a first receive and transmit path 810 can represent the sequence of operations executed by a primary transceiver chain. The first receive and transmit path 810 might be dedicated to servicing a first client device located in a specific spatial sector of the wireless network. Often, the first receive and transmit path 810 can operate independently as it processes a queued physical layer protocol data unit. The first receive and transmit path 810 can dictate the timing for the initial transmission sequence without requiring input from other parallel paths within the device.

In various embodiments, a first random backoff period 811 can be initiated along the first receive and transmit path 810. The first random backoff period 811 might involve a counter decrementing while the device listens for radio frequency energy in the direction of the first client. Often, the duration of the first random backoff period 811 can be established by contention-based access rules to prevent packet collisions. If the targeted spatial sector remains free of interfering signals, the countdown within the first random backoff period 811 can reach zero smoothly.

In further embodiments, a first data transmission period 812 can follow the completion of the first random backoff period 811. The first data transmission period 812 might represent the active sending of the queued physical layer protocol data unit to the first targeted station. Often, the radio frequency energy emitted during the first data transmission period 812 can be highly focused by the antenna array associated with the primary path. The successful execution of the first data transmission period 812 can satisfy the immediate data delivery requirement for that specific network client.

In some embodiments, a second receive and transmit path 820 can operate in parallel with the primary path. The second receive and transmit path 820 might be initially assigned to assess the channel for a second target station located in a different direction. Often, the hardware executing the second receive and transmit path 820 can possess the agility to switch its beam focus dynamically. The second receive and transmit path 820 can represent a flexible resource that the medium access control layer can utilize to bolster active transmissions or assess independent sectors.

In additional embodiments, an initial second random backoff period 821 can begin along the second receive and transmit path 820. The initial second random backoff period 821 might commence while the first path is still conducting its own independent clear channel assessment. Often, this overlapping countdown during the initial second random backoff period 821 can represent a concurrent sensing effort directed strictly toward the second client. The initial second random backoff period 821 can progress seamlessly as long as the device maintains its beam toward the second station and detects no interference.

In many embodiments, a shared first data transmission period 822 can interrupt the secondary countdown sequence. The shared first data transmission period 822 might occur when the secondary path snaps its transmit chain to align with the beam pointing toward the first client. Often, instead of merely pausing its backoff due to internal interference, the second path can actively participate in the transmission to the first client during the shared first data transmission period 822. This cooperative behavior during the shared first data transmission period 822 can potentially increase the signal-to-noise ratio and ensure the successful delivery of the primary packet.

In still more embodiments, a resumed second random backoff period 823 can commence once the active transmission to the first client concludes. The resumed second random backoff period 823 might require the secondary path to snap its beam back to the original direction pointing toward the second client. Often, the resumed second random backoff period 823 can pick up the countdown from the exact value it held prior to the interruption caused by the shared transmission. Once the resumed second random backoff period 823 successfully reaches zero, the device can be authorized to send the queued data to the second client.

In certain embodiments, a second data transmission period 824 can finalize the sequence for the second receive and transmit path 820. The second data transmission period 824 might involve sending the second physical layer protocol data unit directly to the second target station. Often, the second data transmission period 824 can utilize the secondary antenna array exclusively, focusing the radio frequency energy precisely toward the second client. By leveraging the previously accumulated countdown time, the second data transmission period 824 can occur with less overall delay than a strictly sequential processing scheme.

For example, the path-specific operations timing diagram 800 can illustrate a scenario where an access point leverages multiple paths to boost transmission power dynamically. The access point could initiate the first random backoff period 811 and the initial second random backoff period 821 simultaneously in different directions. When the first path finishes its countdown and begins the first data transmission period 812, the access point might determine that the first client requires a stronger signal. In response, the access point can shift the secondary path to join the primary beam, creating the shared first data transmission period 822 to temporarily augment the transmission power.

For instance, the interactions within the path-specific operations timing diagram 800 might improve the reliability of a critical data link in a noisy millimeter wave environment. During the shared first data transmission period 822, combining the output of two separate transceiver chains can yield a more resilient radio frequency link to the first client. This snapping mechanism can allow the network device to prioritize the successful delivery of an active packet without completely discarding the progress made during the initial second random backoff period 821. The ability to pool resources dynamically can be highly advantageous when mitigating sudden environmental interference.

In a non-limiting example, the path-specific operations timing diagram 800 can demonstrate the agility of the medium access control layer in returning to pending tasks. Immediately after the cooperative transmission ends, the device might decouple the two paths, allowing the secondary path to revert to its independent sensing role. The resumed second random backoff period 823 can continue to monitor the medium for the second client, capitalizing on the time already spent counting down before the interruption. Ultimately, this sophisticated timing coordination can allow the second data transmission period 824 to proceed efficiently, balancing the need for transmission power with the goal of overall network latency reduction.

Although a specific embodiment for a path-specific operations timing diagram 800 for carrying out the various steps, processes, methods, and operations described herein is discussed with respect to FIG. 8, any of a variety of systems and/or devices may be utilized in accordance with embodiments of the disclosure. For example, the path-specific operations timing diagram 800 may be extended to depict three or four parallel transceiver paths temporarily pooling their resources to form an exceptionally robust beam for a single distant client before returning to their individual tasks. Furthermore, the duration of the shared transmission phase can be adjusted based on the specific payload requirements of the data frame. The elements depicted in FIG. 8 may also be interchangeable with other elements of FIGS. 1–7 and 9-19 as required to realize a particularly desired embodiment.

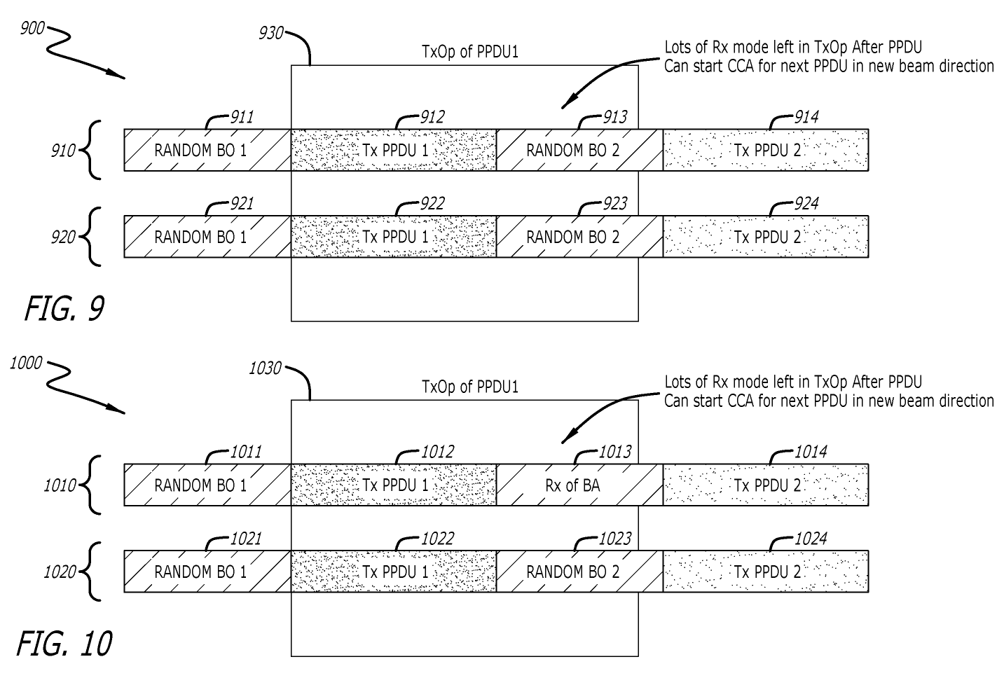

Referring to FIG. 9, a timing diagram 900 illustrating an early clear channel assessment for a second transmission following a first transmission, in accordance with various embodiments of the disclosure is shown. In many embodiments, the timing diagram 900 can represent a scenario where an access point utilizes multiple transmit chains to communicate with a single client device before rapidly shifting to a new target. As millimeter wave communications can rely on highly directional beams, devices might reconfigure their antenna arrays dynamically to optimize data throughput. The timing diagram 900 can demonstrate how a network node can capitalize on unused time within a reserved medium access window to prepare for a subsequent data transfer.

In some embodiments, a first timing path 910 can represent a primary transceiver chain operating within a wireless network device. The first timing path 910 might dictate the sequence of operations for a specific phased antenna array executing a targeted transmission. Often, the first timing path 910 can involve shifting between a listening state and an active transmitting state to facilitate secure and collision-free data exchanges. The actions performed along the first timing path 910 can be coordinated tightly with other internal hardware paths to amplify signal strength toward a designated receiver.

In further embodiments, a first random backoff period 911 can be initiated at the start of the sequence along the first timing path 910. The first random backoff period 911 might involve the primary transceiver chain monitoring a specific spatial sector for existing radio frequency energy. Often, the first random backoff period 911 can ensure that the access point adheres to standard channel access protocols before sending its queued payload. If the medium remains clear, the countdown associated with the first random backoff period 911 can expire, thereby granting the device permission to utilize the wireless channel.

In additional embodiments, a first data transmission period 912 can commence immediately following the successful expiration of the first random backoff period 911. The first data transmission period 912 might represent the physical delivery of a queued data payload to a first target station. Often, the primary transceiver chain can focus its radio frequency energy into a narrow beam directed at the target during the first data transmission period 912. The successful conclusion of the first data transmission period 912 can signify that the payload has left the antenna, though the overarching network reservation might still be active.

In numerous embodiments, a transmit opportunity period 930 can encompass the first data transmission period 912 and extend beyond its conclusion. The transmit opportunity period 930 might define a block of time during which the network device maintains priority access to the wireless medium. Often, the actual duration of the physical transmission can be shorter than the overall transmit opportunity period 930, leaving a residual window of time. The device can exploit this remaining portion of the transmit opportunity period 930 to perform subsequent clear channel assessments in new beam directions.

In more embodiments, a second random backoff period 913 can begin along the first timing path 910 while the transmit opportunity period 930 is still active. The second random backoff period 913 might be initiated right after the transmission is done by changing the beam pattern to point towards a second device. Often, starting the second random backoff period 913 early can provide significant efficiency gains for the network device. The primary transceiver chain can conduct this assessment safely because the surrounding network nodes may still be deferring to the ongoing transmit opportunity period 930.

In certain embodiments, a second data transmission period 914 can occur once the second random backoff period 913 successfully reaches zero. The second data transmission period 914 might represent the delivery of a separate physical layer protocol data unit to the second target station. Often, the second data transmission period 914 can be executed efficiently because the required medium assessment was largely handled during the preceding idle time. The ability to transition smoothly into the second data transmission period 914 can allow the network node to maximize its overall data throughput.

In many embodiments, a second timing path 920 can run concurrently with the primary sequence of operations. The second timing path 920 might represent a secondary transceiver chain that can be utilized to amplify the capabilities of the primary path. Often, the hardware supporting the second timing path 920 can duplicate the actions of the primary path to form a unified, highly focused radio frequency beam. The synchronization between the first timing path 910 and the second timing path 920 can ensure that maximum energy is directed toward the intended receivers.

In some embodiments, a concurrent first random backoff period 921 can be executed along the second timing path 920. The concurrent first random backoff period 921 might mirror the assessment activities occurring on the primary path. Often, the concurrent first random backoff period 921 can involve the secondary transceiver chain pointing its antenna elements in the exact same direction as the primary chain. This unified sensing approach during the concurrent first random backoff period 921 can ensure that the access point maintains a consistent view of the wireless medium.

In further embodiments, a concurrent first data transmission period 922 can follow the shared sensing phase. The concurrent first data transmission period 922 might involve the secondary transceiver chain actively transmitting the same physical layer protocol data unit alongside the primary chain. Often, the combined output during the concurrent first data transmission period 922 can bolster the signal strength reaching the first client device. This cooperative transmission during the concurrent first data transmission period 922 can be especially beneficial for overcoming harsh propagation environments typical of millimeter wave frequencies.

In numerous embodiments, a concurrent second random backoff period 923 can be initiated simultaneously on the secondary path. The concurrent second random backoff period 923 might require the secondary transceiver chain to snap its beam direction to align with the new target station. Often, the concurrent second random backoff period 923 can proceed during the remainder of the original transmit opportunity window. By utilizing multiple receive paths for this new assessment, the concurrent second random backoff period 923 can provide robust detection of any emerging interference.

In additional embodiments, a concurrent second data transmission period 924 can conclude the operations along the second timing path 920. The concurrent second data transmission period 924 might involve the secondary chain assisting in the delivery of the second data payload. Often, the concurrent second data transmission period 924 can leverage the synchronized backoff countdowns to ensure both transceiver chains transmit simultaneously. The cooperative execution of the concurrent second data transmission period 924 can guarantee that the second client receives a high-quality signal.

For example, the components illustrated in the timing diagram 900 can operate together to drastically reduce network latency. An access point might finish sending a packet to a first station during the first data transmission period 912. Rather than waiting for the entire transmit opportunity period 930 to expire before preparing its next move, the access point can immediately shift its focus. By triggering the second random backoff period 913 and the concurrent second random backoff period 923 while the network is still reserved, the device can effectively hide its assessment time. This hidden assessment can allow the subsequent data transmissions to launch almost instantly once the medium is free.

For instance, the timing diagram 900 can demonstrate a strategy for pooling antenna resources dynamically. During the first data transmission period 912 and the concurrent first data transmission period 922, the network device could orient all its phased array elements toward a distant, difficult-to-reach client. Once that robust transmission completes, the device might realize that its next queued packet is destined for a different client located in another spatial sector. The device can seamlessly pivot all of its transceiver chains to point at this new client, initiating the second random backoff period 913 and the concurrent second random backoff period 923 in unison. This resource pooling can ensure that every client receives maximum signal power when needed.

In a non-limiting example, the operations depicted in the timing diagram 900 can highlight the advantages of early clear channel assessments over traditional sequential processing. In a conventional setup, a device might wait until the transmit opportunity period 930 completely closes before scanning the channel for a new destination. However, by executing the second random backoff period 913 while the remainder of the transmit opportunity period 930 is still protecting the channel, the device can guarantee a clean sensing environment. This early start can mean that the second data transmission period 914 and the concurrent second data transmission period 924 can be scheduled tightly against the end of the previous operation. Such tight scheduling can be highly beneficial for accommodating latency-sensitive applications in high-density areas.

Although a specific embodiment for a timing diagram 900 for carrying out the various steps, processes, methods, and operations described herein is discussed with respect to FIG. 9, any of a variety of systems and/or devices may be utilized in accordance with embodiments of the disclosure. For example, the timing diagram 900 may be extended to depict three or more parallel transceiver chains executing these synchronized assessment and transmission steps. The elements depicted in FIG. 9 may also be interchangeable with other elements of FIGS. 1–8 and 10-19 as required to realize a particularly desired embodiment.

Referring to FIG. 10, a concurrent clear channel assessment timing diagram 1000, in accordance with various embodiments of the disclosure is shown. In many embodiments, the concurrent clear channel assessment timing diagram 1000 can illustrate a scenario where one transceiver path remains dedicated to receiving a block acknowledgment while another path begins assessing a new direction. As millimeter wave networks rely heavily on directional beamforming, managing the transition between different target stations can be critical for maintaining high throughput. The concurrent clear channel assessment timing diagram 1000 can demonstrate how a network device might split its antenna resources immediately following a data transmission to perform simultaneous tasks. By keeping one beam focused on the original client and steering another beam toward a new client, the device can potentially maximize the utility of a reserved medium access window.

In various embodiments, a transmit opportunity period 1030 can encompass the initial transmission and the subsequent reception of response frames. The transmit opportunity period 1030 might define a specific duration during which the network device holds priority access to the wireless channel. Often, the active transmission of a physical layer protocol data unit might not consume the entirety of the transmit opportunity period 1030. The network device can utilize the remaining time within the transmit opportunity period 1030 to receive acknowledgments and proactively prepare for the next queued transmission. By leveraging this residual time, the device can effectively hide the assessment delays that would otherwise occur.

In a number of embodiments, a first timing path 1010 can represent the operational sequence for a primary transceiver chain. The first timing path 1010 might dictate the phase shifts and beam orientations applied to a first antenna array during a communication session. Often, the first timing path 1010 can be responsible for maintaining the link with a first target station until all required acknowledgments are successfully received. The activities along the first timing path 1010 can ensure the reliability of the data transfer by verifying that the payload was delivered without errors.

In further embodiments, a first random backoff period 1011 can initiate the sequence along the first timing path 1010. The first random backoff period 1011 might involve the primary transceiver chain actively sensing the wireless medium in the specific direction of the first target station. Often, the first random backoff period 1011 can serve as the primary collision avoidance mechanism before any high-power radio frequency energy is emitted. If the medium remains clear throughout the countdown, the first random backoff period 1011 can expire and grant the device permission to transmit.

In additional embodiments, a first data transmission period 1012 can follow the successful completion of the initial backoff. The first data transmission period 1012 might involve sending the queued physical layer protocol data unit over the targeted millimeter wave beam. Often, the first data transmission period 1012 can consume a significant portion of the allocated transmit opportunity period 1030. The successful execution of the first data transmission period 1012 can deliver the necessary payload to the client, triggering the need for a confirmation response from the receiving end.

In some embodiments, a block acknowledgment reception period 1013 can occur immediately after the data transmission concludes. The block acknowledgment reception period 1013 might require the primary transceiver chain to keep its radio frequency beam pointed directly at the first target station. Often, the block acknowledgment reception period 1013 can capture the response frame that confirms the successful decoding of the previously sent data. By maintaining the spatial focus during the block acknowledgment reception period 1013, the device can ensure that the faint response signal is accurately received without being drowned out by background noise.

In many embodiments, a second data transmission period 1014 can commence once the block acknowledgment is fully processed. The second data transmission period 1014 might represent the delivery of a new data payload to a completely different client device. Often, transitioning to the second data transmission period 1014 can require the primary transceiver chain to rapidly shift its beam orientation to join the secondary transceiver chain. The successful start of the second data transmission period 1014 can mark the beginning of a new communication session with the second target station.

In more embodiments, a second timing path 1020 can represent the simultaneous operations of a secondary transceiver chain within the same network device. The second timing path 1020 might initially mirror the primary chain to bolster signal strength but can diverge to perform independent tasks when needed. Often, the flexibility of the second timing path 1020 can allow the network device to handle multiple spatial sectors concurrently. The second timing path 1020 can be a critical component for reducing latency when multiple packets are queued for different destinations.

In certain embodiments, a concurrent first random backoff period 1021 can be executed along the secondary path. The concurrent first random backoff period 1021 might occur in unison with the primary path, with both antenna arrays pointing toward the first target station. Often, this synchronized sensing during the concurrent first random backoff period 1021 can ensure a highly accurate clear channel assessment. The concurrent first random backoff period 1021 can prevent the secondary path from inadvertently starting a conflicting transmission while the primary path is preparing to send.

In numerous embodiments, a concurrent first data transmission period 1022 can follow the synchronized backoff. The concurrent first data transmission period 1022 might involve the secondary transceiver chain actively contributing radio frequency energy to the primary beam. Often, this cooperative effort during the concurrent first data transmission period 1022 can maximize the signal-to-noise ratio at the receiving station. The concurrent first data transmission period 1022 can be especially useful for reaching distant devices or overcoming physical obstructions in the network environment.

In still more embodiments, a second random backoff period 1023 can be initiated by the secondary transceiver chain while the primary chain waits for a response. The second random backoff period 1023 might require the secondary chain to electronically steer its beam away from the first target station and toward a new target station. Often, the second random backoff period 1023 can proceed safely because the overarching network reservation might still protect the medium from hidden nodes. By conducting the second random backoff period 1023 during this residual time, the device can effectively overlap its assessment and reception tasks.

In further embodiments, a concurrent second data transmission period 1024 can conclude the sequence along the secondary path. The concurrent second data transmission period 1024 might align with the operations of the primary path to deliver the next queued packet. Often, the concurrent second data transmission period 1024 can begin immediately after the primary path finishes receiving its acknowledgment and steers its beam to match the secondary path. This synchronization during the concurrent second data transmission period 1024 can ensure that the second client receives a robust, high-quality signal from multiple antenna arrays.

For example, the elements of the concurrent clear channel assessment timing diagram 1000 can work together to optimize airtime utilization. A network device could transmit a large video frame using both the first data transmission period 1012 and the concurrent first data transmission period 1022. Once the video frame is sent, the device might split its resources, using the block acknowledgment reception period 1013 to listen for a confirmation from the video recipient while simultaneously using the second random backoff period 1023 to check the channel for a pending web browsing packet destined for another user. This splitting of resources can allow the device to multitask effectively, reducing the idle time between discrete communication events.

For instance, the concurrent clear channel assessment timing diagram 1000 might demonstrate a strategy for handling latency-sensitive applications. If the second queued packet contains critical control data, the network device can prioritize its preparation by starting the second random backoff period 1023 at the earliest possible moment. While the primary path is occupied with the block acknowledgment reception period 1013, the secondary path can quietly confirm that the medium is clear in the new direction. As soon as the acknowledgment is verified, both paths can immediately launch into the second data transmission period 1014 and the concurrent second data transmission period 1024, ensuring minimal delay for the critical data.

In a non-limiting example, the concurrent clear channel assessment timing diagram 1000 can illustrate how dynamic beam steering can resolve conflicting hardware requirements. After a cooperative transmission, the primary antenna array must remain focused on the original target to catch the incoming response during the block acknowledgment reception period 1013. However, waiting for this reception to finish before starting a new assessment would waste valuable time within the transmit opportunity period 1030. By reallocating the secondary antenna array to conduct the second random backoff period 1023, the device can satisfy both the need for a reliable acknowledgment reception and the need for a rapid subsequent transmission.

Although a specific embodiment for a concurrent clear channel assessment timing diagram 1000 for carrying out the various steps, processes, methods, and operations described herein is discussed with respect to FIG. 10, any of a variety of systems and/or devices may be utilized in accordance with embodiments of the disclosure. For example, the concurrent clear channel assessment timing diagram 1000 may be adapted to show three or more independent timing paths managing complex acknowledgment sequences across multiple spatial sectors. The elements depicted in FIG. 10 may also be interchangeable with other elements of FIGS. 1–9 and 11-19 as required to realize a particularly desired embodiment.

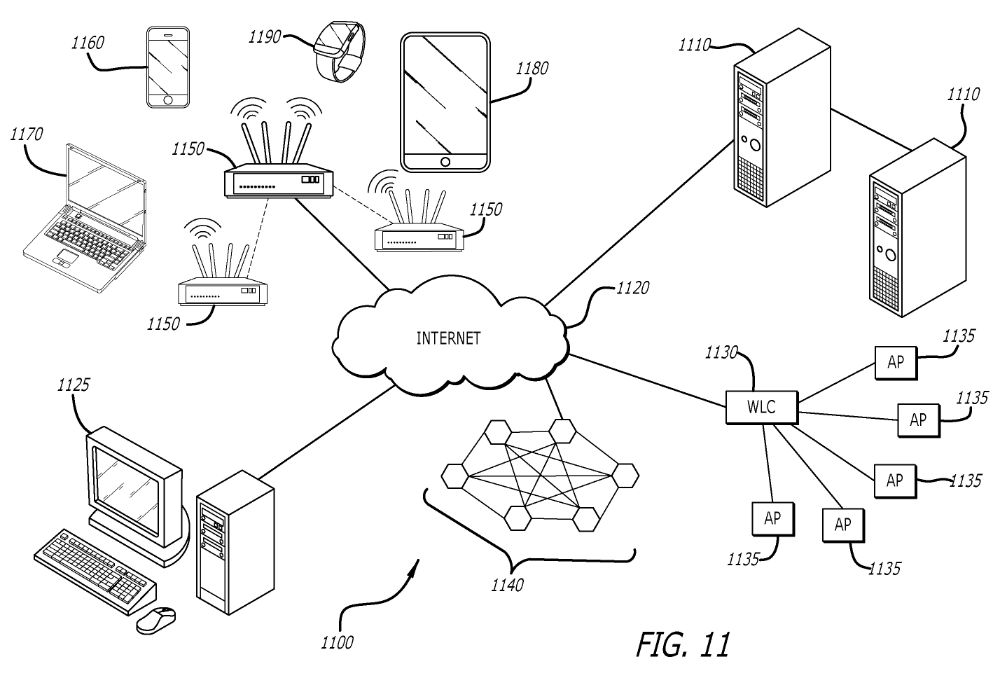

Referring to FIG. 11, a schematic diagram of a network environment 1100 including access points and client devices, in accordance with various embodiments of the disclosure is shown. In many embodiments, the network environment 1100 can represent a versatile deployment architecture capable of supporting the concurrent clear channel assessment logic described herein. The network environment 1100 might encompass a wide variety of computing devices spread across local, remote, and distributed settings. Often, the configuration of the network environment 1100 can be scaled to accommodate everything from small residential setups to massive enterprise deployments. By leveraging the diverse components within the network environment 1100, the system can potentially optimize millimeter wave communications and reduce spatial latency.

In a number of embodiments, a remote server 1110 can provide centralized processing and storage capabilities for the overall system. The remote server 1110 might host complex machine learning models or centralized network management applications that require significant computational power. Often, the remote server 1110 can process telemetry data gathered from various wireless nodes to determine optimal beamforming strategies. The remote server 1110 can be situated in a cloud computing facility, allowing it to serve multiple distinct network deployments concurrently.

In further embodiments, an internet 1120 can serve as the primary communication backbone linking the disparate elements of the system. The internet 1120 might facilitate the exchange of control signals and data payloads between remote datacenters and local wireless infrastructure. Often, the internet 1120 can encompass a vast array of public and private fiber optic, copper, and wireless conduits. By utilizing the internet 1120, the various local and remote components can maintain synchronization and share critical updates regarding channel assessments and spatial allocations.

In additional embodiments, a local computer 1125 can be deployed as an administrative or monitoring workstation within the network. The local computer 1125 might execute local dashboard applications that visualize the performance of concurrent clear channel assessments happening in real time. Often, a network administrator can utilize the local computer 1125 to manually override automated policies or to establish new spatial sector configurations. The local computer 1125 can be connected directly to the local routing infrastructure or might access the system securely through the internet 1120.

In some embodiments, a wireless LAN controller 1130 can act as a localized management hub for a fleet of access points. The wireless LAN controller 1130 might coordinate the channel assignments, security protocols, and beamforming schedules for numerous wireless nodes. Often, the wireless LAN controller 1130 can process interference reports to determine if specific spatial sectors are suffering from degraded isolation. By centralizing these decisions at the wireless LAN controller 1130, the system can potentially ensure that parallel transmission paths do not inadvertently collide.

In many further embodiments, an access point 1135 can represent the physical layer edge of the network infrastructure. The access point 1135 might house the multiple phased antenna arrays necessary for executing the concurrent sensing and transmitting operations. Often, the access point 1135 can independently evaluate backoff countdowns for distinct spatial sectors under the overarching guidance of the wireless LAN controller 1130. The access point 1135 can seamlessly steer its radio frequency beams to service various target clients as they move through the coverage area.

In yet more embodiments, a distributed environment 1140 can represent a mesh network or peer-to-peer computing architecture. The distributed environment 1140 might offload certain processing tasks from the centralized servers, handling clear channel assessment coordination directly at the edge. Often, nodes within the distributed environment 1140 can share localized interference data with one another to dynamically adjust their respective beam angles. By leveraging the decentralized nature of the distributed environment 1140, the system can potentially achieve higher resilience and lower latency than strictly centralized models.

In still additional embodiments, a wireless router 1150 can provide standalone connectivity for smaller or less complex deployments. The wireless router 1150 might combine the functions of a traditional gateway, a firewall, and a multi-path transceiver into a single appliance. Often, the wireless router 1150 can deploy concurrent clear channel assessments to manage heavy multimedia traffic in dense residential environments. The wireless router 1150 can communicate with other similar devices or upstream infrastructure to negotiate spectrum utilization.

In certain embodiments, a mobile phone 1160 can be a common end-user device operating within the wireless coverage area. The mobile phone 1160 might frequently request latency-sensitive data streams, such as voice over internet protocol or live video. Often, the mobile phone 1160 can utilize advanced millimeter wave receivers to capture highly directional signals. The mobile phone 1160 can benefit from the network's parallel processing capabilities, potentially receiving its queued packets much faster than in traditional sequentially managed networks.

In numerous embodiments, a laptop computer 1170 can serve as another target station requiring high-throughput wireless access. The laptop computer 1170 might engage in heavy file transfers or complex cloud-based applications that demand substantial bandwidth. Often, the laptop computer 1170 can be positioned in a relatively stationary location, making it an ideal target for a focused, long-duration transmission beam. The laptop computer 1170 can process incoming protocol data units and transmit necessary response frames back to the servicing access point.

In various embodiments, a tablet device 1180 can represent an additional mobile computing station within the ecosystem. The tablet device 1180 might alternate rapidly between active data consumption and idle listening states to conserve battery life. Often, the tablet device 1180 can leverage early clear channel assessments performed by the access point to immediately resume its data sessions upon waking. The tablet device 1180 can interpret targeted initial control frames to synchronize its reception hardware with the incoming directional payload.

In some additional embodiments, a smartwatch 1190 can be a wearable client with strict power and size constraints. The smartwatch 1190 might only require intermittent bursts of data for notifications and health telemetry synchronization. Often, the smartwatch 1190 can be serviced concurrently with other heavier traffic devices without disrupting their high-bandwidth sessions. By efficiently directing a separate radio frequency beam toward the smartwatch 1190 during a parallel countdown, the network can potentially maintain optimal efficiency across all device classes.

For example, the various components within the network environment 1100 can cooperate to execute cloud-managed spatial isolation policies. The remote server 1110 could analyze historical traffic patterns and transmit updated configuration models across the internet 1120 to the wireless LAN controller 1130. The wireless LAN controller 1130 might then instruct the access point 1135 to enable concurrent clear channel assessments for specifically isolated geographic sectors. Consequently, the access point 1135 could begin simultaneously assessing the medium for both the mobile phone 1160 and the laptop computer 1170, dramatically reducing the queuing delays for both devices.

For instance, the system might be configured to operate effectively within the decentralized framework of the distributed environment 1140. A group of interconnected wireless routers 1150 could form a self-healing mesh that coordinates transmission schedules locally without relying on the remote server 1110. One wireless router 1150 might direct a transmission to the tablet device 1180 while concurrently sensing a different sector to prepare a transmission for the smartwatch 1190. If localized interference is detected, the nodes within the distributed environment 1140 can dynamically share this telemetry to pause or reroute specific backoff operations across the mesh.

In a non-limiting example, an administrator might utilize the local computer 1125 to troubleshoot latency issues experienced by specific clients. The administrator could log into the local computer 1125 and adjust the backoff priority settings for the access point 1135 targeting the mobile phone 1160. These changes might propagate through the local network or be routed up through the internet 1120 for verification. As a result, the access point 1135 might dedicate an exclusive antenna array to the mobile phone 1160, allowing its associated clear channel assessment to continue uninterrupted even while the access point 1135 transmits cooperative beams to the laptop computer 1170 and the tablet device 1180.

Although a specific embodiment for a network environment 1100 for carrying out the various steps, processes, methods, and operations described herein is discussed with respect to FIG. 11, any of a variety of systems and/or devices may be utilized in accordance with embodiments of the disclosure. For example, the network environment 1100 might incorporate cellular base stations, satellite links, or customized industrial sensors to support diverse connectivity requirements. The elements depicted in FIG. 11 may also be interchangeable with other elements of FIGS. 1–10 and 12-19 as required to realize a particularly desired embodiment.

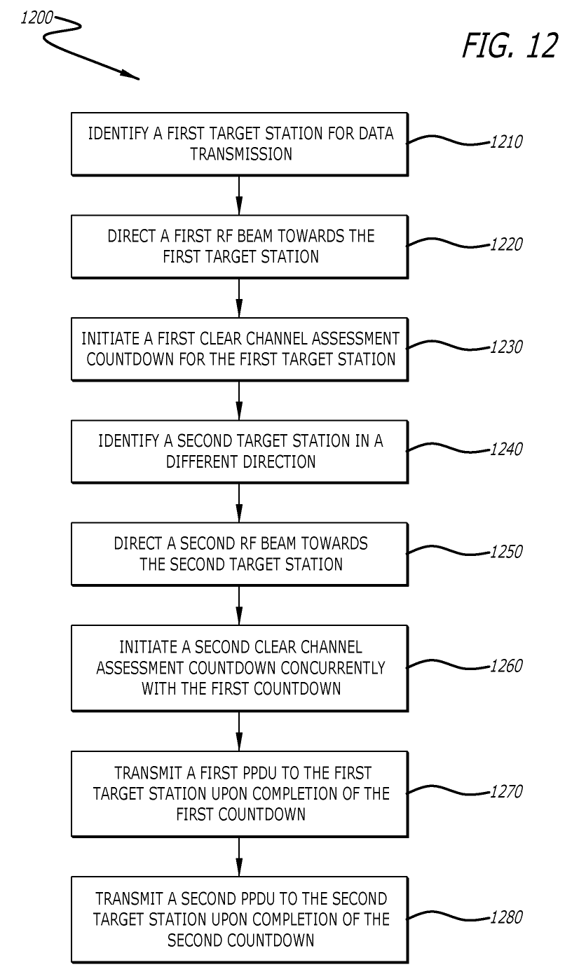

Referring to FIG. 12, a flowchart depicting a process 1200 for concurrent clear channel assessments in accordance with various embodiments of the disclosure is shown. The process 1200 can represent a highly efficient operational sequence for devices utilizing directional communication. By executing multiple assessments in parallel, network nodes can significantly reduce data latency across a crowded wireless environment. This parallel execution can be especially critical for maintaining high throughput in dense millimeter wave deployments where spatial reuse is paramount.

In many embodiments, the process 1200 can identify a first target station for data transmission (block 1210). This identification might involve parsing a hardware queue to find pending packets destined for a specific client device. For example, the process 1200 could determine the target based on an urgent stream classification service request. Alternatively, the identification can be scheduled periodically based on a centralized polling mechanism to ensure fair airtime distribution across the network.

In a number of embodiments, the process 1200 can direct a first RF beam towards the first target station (block 1220). The direction of the energy can be accomplished by applying specific phase shifts to an analog antenna array. For instance, digital beamforming algorithms might calculate the optimal trajectory to maximize signal strength at the receiving end. In another approach, the beam direction can be retrieved from a previously stored location cache associated with that specific station to expedite the connection process.

In more embodiments, the process 1200 can initiate a first clear channel assessment countdown for the first target station (block 1230). Initiating this countdown can involve starting a random backoff timer while continuously monitoring the targeted spatial sector for interfering radio frequency energy. In a non-limiting example, if energy is detected above a certain threshold, the countdown might be temporarily suspended until the channel is clear again. Conversely, the countdown can utilize a fixed duration rather than a randomized backoff if the network operates under strict deterministic scheduling constraints.

In further embodiments, the process 1200 can identify a second target station in a different direction (block 1240). This secondary identification can be triggered when multiple physical layer protocol data units arrive in the medium access control layer almost simultaneously. For example, the process 1200 might actively seek out targets located in distinct geographic sectors to maximize the spatial reuse capabilities of the hardware. Alternatively, the selection of the second station can be dictated by quality of service requirements that prioritize low-latency traffic over standard background data.

In additional embodiments, the process 1200 can direct a second RF beam towards the second target station (block 1250). This beam steering can utilize an entirely independent physical transceiver path to ensure the energy profiles remain separate. For instance, the process 1200 can electronically adjust a secondary phased array to focus precisely on the location of the newly identified client. In other implementations, a single massive antenna array might be partitioned logically to generate multiple independent beams concurrently.

In still more embodiments, the process 1200 can initiate a second clear channel assessment countdown concurrently with the first countdown (block 1260). Running parallel countdowns can drastically reduce the overall waiting period required before executing pending transmissions. For example, the process 1200 could run a parallel hardware timer that listens exclusively to the sector covered by the secondary beam. Alternatively, a software-defined logic controller can manage multiple virtual backoff instances overlaid on a single physical sensing component.

In yet further embodiments, the process 1200 can transmit a first PPDU to the first target station upon completion of the first countdown (block 1270). The transmission can involve modulating the queued data into a high-frequency millimeter wave format for physical delivery over the air. In a non-limiting example, the physical layer protocol data unit can contain a large video payload requiring substantial, uninterrupted bandwidth. Alternatively, the transmitted packet can be a short, latency-sensitive control frame designed to synchronize operations across the local area network.

In still additional embodiments, the process 1200 can transmit a second PPDU to the second target station upon completion of the second countdown (block 1280). This secondary transmission can occur immediately after the parallel timer expires, regardless of whether the primary transmission has entirely finished. For instance, both data units can be sent entirely simultaneously if sufficient internal radio frequency isolation exists between the two transmit chains. In another approach, the process 1200 might introduce a slight microsecond offset between the start times to prevent sudden power surges across the hardware components.

For example, the process 1200 can be executed by a central router in a busy enterprise environment to manage dense traffic efficiently. The router might identify a laptop downloading a file and a smartphone initiating a voice call, triggering the parallel sensing mechanisms. By isolating the spatial sectors, the router can prevent the two separate monitoring paths from interfering with one another. By successfully completing the concurrent countdowns, the router can transmit both data payloads simultaneously, ensuring the voice call remains clear while the file download proceeds rapidly.

For instance, the process 1200 could be deployed within an edge mesh node operating in an industrial automation facility. The node might direct independent beams toward a robotic arm and a monitoring sensor located in opposite corners of the factory floor. The parallel assessments can allow the node to bypass sequential waiting periods, ensuring that critical control instructions reach both machines with minimal delay. This simultaneous operation can be vital for maintaining strict safety tolerances and synchronization across the automated machinery.

In a non-limiting example, the process 1200 can enable a public millimeter wave hotspot to serve multiple users without causing bottlenecks. As new users request access, the hotspot can dynamically assign distinct antenna arrays and initialize parallel countdowns for each user's data queue. This ability to concurrently evaluate the medium and transmit across different sectors can drastically improve the overall user experience in crowded venues. The hotspot can continually cycle through these assessments, reassigning beams as users physically move through the coverage area.

Although a specific embodiment for a process 1200 for concurrent clear channel assessments suitable for carrying out the various steps, processes, methods, and operations described herein is discussed with respect to FIG. 12, any of a variety of systems and/or processes may be utilized in accordance with embodiments of the disclosure. For example, the process 1200 can conduct these steps continuously in a looping fashion to handle an infinite queue of incoming traffic. Additionally, the use of optional embodiments does not indicate that the remaining elements are non-optional, but is presented to highlight a separate embodiment. The elements depicted in FIG. 12 may also be interchangeable with other elements of FIGS. 1–11 and 13-19 as required to realize a particularly desired embodiment.

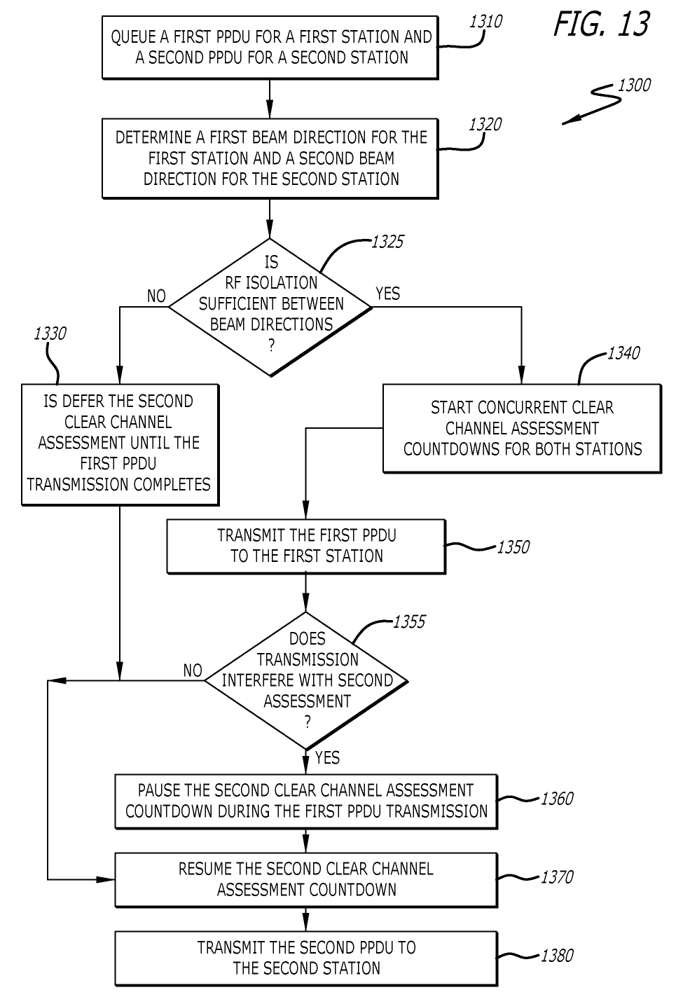

Referring to FIG. 13, a flowchart depicting a process 1300 for managing concurrent backoff counters in accordance with various embodiments of the disclosure is shown. The process 1300 can represent a dynamic approach to handling multiple transmission queues across spatially separated paths. By intelligently evaluating the interactions between different radio frequency beams, network devices can maximize their efficiency. This capability can allow the system to perform simultaneous actions without violating standard collision avoidance protocols.

In many embodiments, the process 1300 can queue a first PPDU for a first station and a second PPDU for a second station (block 1310). For example, a local machine serving as an access point might organize incoming data traffic into separate hardware buffers based on the targeted recipients. In a non-limiting example, a remote device managed by a cloud controller could dynamically allocate queue priorities for latency-sensitive payloads. It is contemplated that the queuing mechanism can be distributed across multiple nodes in a decentralized network to balance traffic loads. These packets might contain high-definition video streams or critical telemetry data requiring rapid delivery over the wireless medium.

In a number of embodiments, the process 1300 can determine a first beam direction for the first station and a second beam direction for the second station (block 1320). For instance, a portable device operating as a mobile hotspot can calculate the spatial vectors needed to reach its connected peers utilizing phased antenna arrays. In another approach, a distributed environment could utilize shared physical layer data to triangulate the optimal trajectories for concurrent signaling. It is contemplated that this determination might be periodically updated as the targeted devices move throughout the coverage area. By accurately establishing these trajectories, the system can potentially maximize signal strength while reducing lateral energy leakage.

In more embodiments, the process 1300 can determine if RF isolation is sufficient between beam directions (block 1325). If it is determined that RF isolation is not sufficient, then the process 1300 can defer the second clear channel assessment until the first PPDU transmission completes (block 1330). However, if it is determined that RF isolation is sufficient, then the process 1300 can start concurrent clear channel assessment countdowns for both stations (block 1340). For example, a local router could evaluate internal cross-talk specifications to ensure that listening operations are not overwhelmed by active transmission chains. In a non-limiting example, a network controller might require a minimum decibel separation threshold between spatial sectors before authorizing parallel actions.

In further embodiments, the process 1300 can defer the second clear channel assessment until the first PPDU transmission completes (block 1330). For instance, an access point facing significant environmental reflections might hold off on secondary sensing to avoid false busy readings. In another application, a remote device handling dense urban traffic might implement this deferral to guarantee the integrity of a high-priority packet delivery. It is contemplated that the deferral mechanism can be selectively overridden by an administrator monitoring the network via a local machine. This conservative approach can ensure strict adherence to collision avoidance protocols when spatial separation is inadequate.

In additional embodiments, the process 1300 can start concurrent clear channel assessment countdowns for both stations (block 1340). For example, a high-capacity gateway might activate dual hardware counters that independently monitor separate geographic quadrants. In a non-limiting example, a portable device equipped with multiple transceivers could execute overlapping backoff timers to dramatically reduce its total airtime footprint. It is contemplated that the simultaneous countdowns might utilize different backoff window sizes depending on the specific traffic category assigned to each queue. This parallel operation can unlock significant throughput enhancements inherent to millimeter wave networking.

In still more embodiments, the process 1300 can transmit the first PPDU to the first station (block 1350). For instance, an enterprise node could modulate the queued payload into a highly focused electromagnetic wave propagating toward a specific user. In another scenario, a mesh node in a distributed environment might send synchronization frames to a neighboring node while maintaining its spatial isolation. It is contemplated that the transmission could utilize custom physical layer characteristics dictated by a remote management server. Delivering this initial packet can fulfill the immediate bandwidth requirements of the primary targeted client.

In yet further embodiments, the process 1300 can determine if transmission interferes with second assessment (block 1355). If it is determined that transmission does not interfere with the second assessment, then the process 1300 can resume the second clear channel assessment countdown (block 1370). However, if it is determined that transmission does interfere with the second assessment, then the process 1300 can pause the second clear channel assessment countdown during the first PPDU transmission (block 1360). For example, the device might dynamically monitor its own internal receive paths for signal clipping or saturation caused by its own active antennas. In a non-limiting example, a remote device might utilize historical interference logs to preemptively predict if the primary payload delivery will disrupt the secondary sensing task.

In still additional embodiments, the process 1300 can pause the second clear channel assessment countdown during the first PPDU transmission (block 1360). For instance, a wireless router could temporarily freeze a digital backoff timer exactly at its current microsecond value. In another embodiment, a local machine might redirect the secondary antenna elements to participate in the primary transmission instead of idly waiting. It is contemplated that the duration of the pause might correspond exactly to the duration of the active physical layer event. By halting the assessment, the device can potentially avoid resetting the entire collision avoidance sequence due to self-generated noise.

In yet more embodiments, the process 1300 can resume the second clear channel assessment countdown (block 1370). For example, once the primary delivery concludes, a control logic might unfreeze the timer and continue scanning the secondary spatial sector. In a non-limiting example, a node in a distributed environment could steer its array back to the secondary target and immediately pick up the backoff process where it left off. It is contemplated that the resumption might involve a brief recalibration period to ensure the hardware is fully recovered from the high-power output. This resumption capability can efficiently preserve the time already invested in the secondary channel check.

In numerous embodiments, the process 1300 can transmit the second PPDU to the second station (block 1380). For instance, a local machine could finalize its queue processing by sending the remaining data burst into the newly secured channel. In another approach, a portable device could rapidly execute this secondary transfer, thereby clearing its buffers before migrating to a new physical location. It is contemplated that this secondary transmission might immediately trigger another cycle of assessments if further traffic is waiting. Completing this step can successfully resolve the multi-destination queueing scenario managed by the overall system.

For example, the process 1300 can be deployed on a local machine, such as a smart home wireless router, to manage a dense network of portable devices. The router might queue data for a smart television and a smart thermostat positioned in different rooms. By evaluating the physical layout, the router could determine that the spatial separation provides excellent isolation, allowing it to start concurrent clear channel assessment countdowns for both stations. If the transmission to the television does not cause internal crosstalk, the router can proceed without pausing, swiftly delivering both payloads in a fraction of the traditional time.

For instance, the process 1300 might operate within a distributed environment comprising interconnected enterprise access points. One of these access points could identify two target clients located in closely overlapping sectors. The access point might determine that the radio frequency isolation is not sufficient, prompting it to defer the second clear channel assessment entirely until the first transmission is finalized. This cautious execution can ensure that the mission-critical traffic in the corporate network does not suffer from self-inflicted collisions or corrupted frames.

In a non-limiting example, a remote device such as a cloud-managed industrial controller could utilize the process 1300 to orchestrate robotic machinery. The controller might attempt to simultaneously assess channels for two distinct assembly line robots. While the concurrent countdowns begin successfully, the start of the first heavy data burst might leak energy into the secondary receive path. The system can dynamically detect this and pause the secondary countdown, safely resuming it only after the first robot has received its full instruction set, thereby maintaining strict operational reliability.

Although a specific embodiment for a process 1300 for managing concurrent backoff counters suitable for carrying out the various steps, processes, methods, and operations described herein is discussed with respect to FIG. 13, any of a variety of systems and/or processes may be utilized in accordance with embodiments of the disclosure. For example, the process 1300 could be adapted to evaluate isolation requirements across three or more simultaneous transmissions dynamically. Additionally, the use of optional embodiments does not indicate that the remaining elements are non-optional, but is presented to highlight a separate embodiment. The elements depicted in FIG. 13 may also be interchangeable with other elements of FIGS. 1–12 and 14-19 as required to realize a particularly desired embodiment.

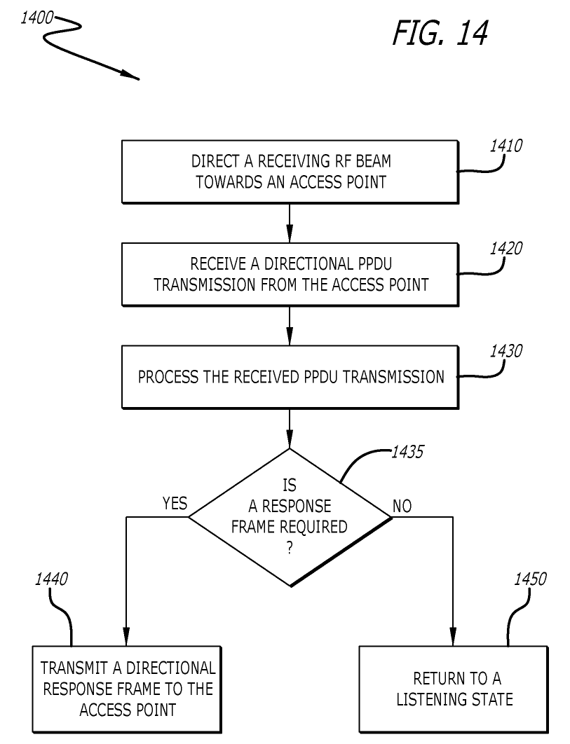

Referring to FIG. 14, a flowchart depicting a process 1400 for receiving directional transmissions and transmitting responses in accordance with various embodiments of the disclosure is shown. The process 1400 can represent the operational steps executed by a client device operating within a high-frequency wireless environment. By utilizing directional sensing and transmission, devices can effectively communicate over millimeter wave frequencies despite inherent propagation challenges. This capability can allow the system to maintain robust and collision-free connections across diverse networking topologies.

In many embodiments, the process 1400 can direct a receiving RF beam towards an access point (block 1410). For example, a portable device might utilize an internal phased array antenna to electronically steer its listening capabilities toward a known signal source. In another approach, the device can periodically sweep its receiving antennas across multiple sectors to discover optimal connection paths. It is contemplated that a local machine could rely on previously cached location data to instantly align its receiving components without a full sweep. By focusing its reception parameters, the device can effectively filter out extraneous noise and improve signal fidelity.

In a number of embodiments, the process 1400 can receive a directional PPDU transmission from the access point (block 1420). The transmission might consist of a high-throughput data payload specifically formatted for millimeter wave delivery. For instance, a remote device acting as an edge sensor could capture incoming control instructions structured within this physical layer protocol data unit. Alternatively, the transmission can represent a beacon or management frame designed to synchronize the timing of the local network. Receiving the data directionally can ensure that the underlying hardware maintains adequate isolation from other concurrent network activities.

In more embodiments, the process 1400 can process the received PPDU transmission (block 1430). Processing the data might involve demodulating the radio frequency signals and passing the resulting digital information up through the communication layers for further analysis. In a non-limiting example, a portable device could decode the payload to extract a video stream intended for an end user. Conversely, the processing action can focus solely on evaluating the header information to determine the integrity and origin of the packet. It is contemplated that a distributed environment could share the processing load across multiple localized processors to reduce computational bottlenecks.

In further embodiments, the process 1400 can determine if a response frame is required (block 1435). If it is determined that a response frame is not required, then the process 1400 can return to a listening state (block 1450). However, if it is determined that a response frame is required, then the process 1400 can transmit a directional response frame to the access point (block 1440). For example, the device might evaluate the sequence control fields within the processed packet to see if an acknowledgment is mandated by the networking protocol. In another scenario, the absence of a response requirement might allow a portable device to immediately power down its transceivers to conserve battery life.

In additional embodiments, the process 1400 can return to a listening state (block 1450). Returning to this idle condition might involve resetting the phased antenna array to an omnidirectional mode or a default sweeping pattern to await further instructions. For instance, a local machine could use this listening state to continuously monitor the medium for subsequent data bursts without actively broadcasting any signals. Alternatively, the device might enter a targeted listening state focused exclusively on the last known location of the access point. It is contemplated that maintaining this listening posture can ensure the device remains synchronized with the overarching distributed environment.

In still more embodiments, the process 1400 can transmit a directional response frame to the access point (block 1440). The response frame might be a block acknowledgment or a clear-to-send signal that confirms the successful receipt of the preceding data. In a non-limiting example, a remote device could utilize the exact same physical path and beam angle used for reception to instantly fire back the required confirmation. Conversely, the device might apply a slightly modified spatial trajectory to circumvent temporary environmental obstructions that arose during the initial exchange. By transmitting this response directionally, the device can avoid polluting the local spectrum with unnecessary omnidirectional noise.

For example, the process 1400 can be deployed on a portable device, such as a modern smartphone, navigating a densely populated wireless network. The portable device could utilize its internal logic to aim its receiving antennas toward the primary access point within an auditorium. Upon receiving and processing a high-bandwidth video packet, the portable device might determine that a block acknowledgment is necessary to sustain the stream. Consequently, it can immediately transmit the directional response frame back along the same trajectory, ensuring the access point knows the packet was successfully decoded.

For instance, the process 1400 might be utilized within a local machine functioning as a smart television in a home automation setup. The local machine could continuously direct a receiving RF beam toward a central home router operating on millimeter wave frequencies. If the router pushes a routine status update that does not mandate a formal reply, the local machine can process the data and gracefully drop back into a passive listening state. This ability to intelligently return to a listening state without broadcasting unnecessary replies can minimize the overall radio frequency footprint of the local machine.

In a non-limiting example, a remote device located within a sprawling distributed environment could execute the process 1400 to maintain synchronized mesh operations. The remote device might act as a relay node, capturing highly directional transmissions from a primary controller. Once the payload is processed, the remote device can determine that a response frame is required to validate the network's structural integrity. By transmitting a highly focused response frame back to the controller, the remote device can facilitate seamless coordination across the entire distributed environment without causing interference to parallel communication pathways.

Although a specific embodiment for a process 1400 for receiving directional transmissions and transmitting responses suitable for carrying out the various steps, processes, methods, and operations described herein is discussed with respect to FIG. 14, any of a variety of systems and/or processes may be utilized in accordance with embodiments of the disclosure. For example, the process 1400 can incorporate additional cryptographic verification steps prior to transmitting any response frames. Additionally, the use of optional embodiments does not indicate that the remaining elements are non-optional, but is presented to highlight a separate embodiment. The elements depicted in FIG. 14 may also be interchangeable with other elements of FIGS. 1–13 and 15-19 as required to realize a particularly desired embodiment.

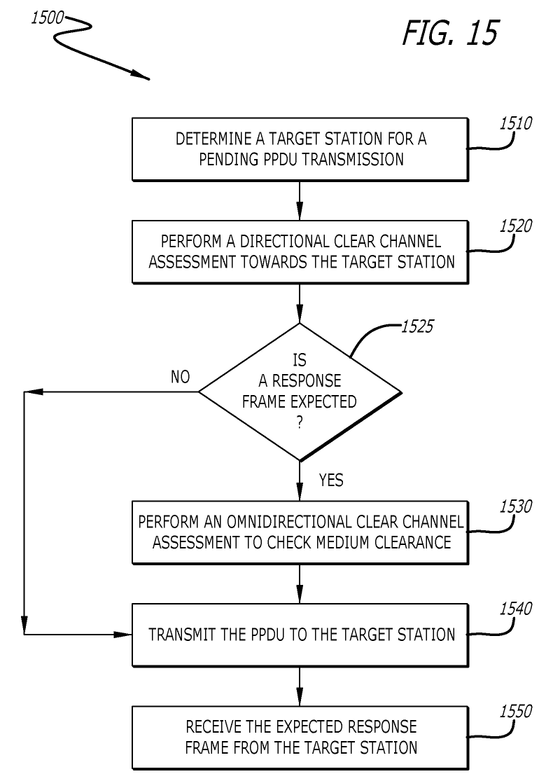

Referring to FIG. 15, a flowchart depicting a process 1500 for performing a supplemental omnidirectional clear channel assessment for response frames in accordance with various embodiments of the disclosure is shown. The process 1500 can represent a strategic approach to managing medium access in environments where directional transmissions are heavily utilized. By evaluating both the specific transmission corridor and the broader surrounding area, network devices can safeguard critical return traffic. This comprehensive sensing capability can allow the system to maintain robust connections across diverse networking topologies, including deployments involving remote devices and portable devices.

In many embodiments, the process 1500 can determine a target station for a pending PPDU transmission (block 1510). This determination can involve analyzing a hardware queue to identify the next client device scheduled to receive data over the wireless network. In another approach, the system can utilize a quality-of-service scheduler to prioritize latency-sensitive traffic over standard background payloads. For example, a local machine serving as a wireless router could evaluate its buffers to select a specific portable device requiring an urgent video stream update.

In a number of embodiments, the process 1500 can perform a directional clear channel assessment towards the target station (block 1520). This assessment can be executed by steering a phased antenna array to listen exclusively in the spatial sector occupied by the intended recipient. Alternatively, the assessment might utilize a wider beam configuration if the precise location of the targeted client is temporarily unknown or fluctuating. For instance, a remote device acting as an enterprise access point could focus its listening capabilities on a narrow corridor to avoid detecting interference from neighboring offices or distinct network segments.

In more embodiments, the process 1500 can determine if a response frame is expected (block 1525). This determination might involve inspecting the specific protocol requirements associated with the queued data payload to see if an acknowledgment is mandated. If it is determined that a response frame is not expected, then the process 1500 can transmit the PPDU to the target station (block 1540). However, if it is determined that a response frame is expected, then the process 1500 can perform an omnidirectional clear channel assessment to check medium clearance (block 1530).

In further embodiments, the process 1500 can perform an omnidirectional clear channel assessment to check medium clearance (block 1530). The omnidirectional assessment can ensure that the local area is free of transmissions that might collide with the acknowledgment signal returning from the client. In another implementation, this broader channel check can be limited to a specific subset of antennas rather than a truly spherical pattern to conserve power while still providing adequate coverage. For example, a distributed environment node might temporarily suspend its strict directional focus to listen for any nearby hidden nodes broadcasting across the general operating frequency.

In additional embodiments, the process 1500 can transmit the PPDU to the target station (block 1540). This transmission can utilize the previously established directional beam to deliver the data efficiently over high-frequency millimeter wave bands. Alternatively, the transmission could incorporate multiple spatial streams if the receiving hardware supports advanced multiple-input multiple-output configurations. In a non-limiting example, a local machine could push a heavy firmware update to an internet-of-things device without requiring any further channel contention once the assessment phases are cleared.

In still more embodiments, the process 1500 can receive the expected response frame from the target station (block 1550). The reception can involve capturing a block acknowledgment confirming the successful delivery of the previously transmitted data payload. In another scenario, the response frame might be a simple clear-to-send message that negotiates the parameters for an upcoming continuous data exchange. It is contemplated that a portable device could rapidly process this incoming response to finalize the network transaction before smoothly transitioning into a low-power sleep state.

For example, the process 1500 can be deployed on a local machine serving as a home wireless router to manage communications with a portable device like a smartphone. The local machine might determine the smartphone is the target station for a pending video stream and perform a highly directional clear channel assessment towards it. Because the video stream requires continuous block acknowledgments, the local machine can determine a response frame is expected and perform a supplemental omnidirectional clear channel assessment. This ensures that no hidden devices in the living room interfere with the smartphone's critical response frame, allowing the data transmission and reception cycle to proceed flawlessly.

For instance, a remote device functioning as a centralized cloud-managed access point can utilize the process 1500 to handle dense enterprise traffic. The remote device could queue a large database file for a specific workstation and quickly execute a directional assessment to secure the forward path. Acknowledging that enterprise protocols demand strict receipt verification, the remote device might briefly open its listening parameters to conduct an omnidirectional check for local interference. By confirming the entire surrounding medium is quiet, the remote device can confidently transmit the data and receive the expected acknowledgment without unexpected collisions corrupting the file transfer.

In a non-limiting example, the process 1500 can be integrated into a distributed environment consisting of autonomous mesh network nodes. A transmitting node might need to forward synchronization data to a neighboring node and will first evaluate the specific spatial vector connecting them. Since mesh architectures heavily rely on confirmed data handoffs, the transmitting node can recognize that a response frame is mandatory and perform an omnidirectional sweep to verify the absence of competing mesh traffic. Once the omnidirectional clearance is confirmed, the transmitting node can send the payload and safely receive the response, ensuring the distributed environment remains perfectly synchronized.

Although a specific embodiment for a process 1500 for performing a supplemental omnidirectional clear channel assessment for response frames suitable for carrying out the various steps, processes, methods, and operations described herein is discussed with respect to FIG. 15, any of a variety of systems and/or processes may be utilized in accordance with embodiments of the disclosure. For example, the process 1500 can be adapted to dynamically skip the omnidirectional check if the network environment is determined to be strictly controlled and free of hidden nodes. Additionally, the use of optional embodiments does not indicate that the remaining elements are non-optional, but is presented to highlight a separate embodiment. The elements depicted in FIG. 15 may also be interchangeable with other elements of FIGS. 1–14 and 16-19 as required to realize a particularly desired embodiment.

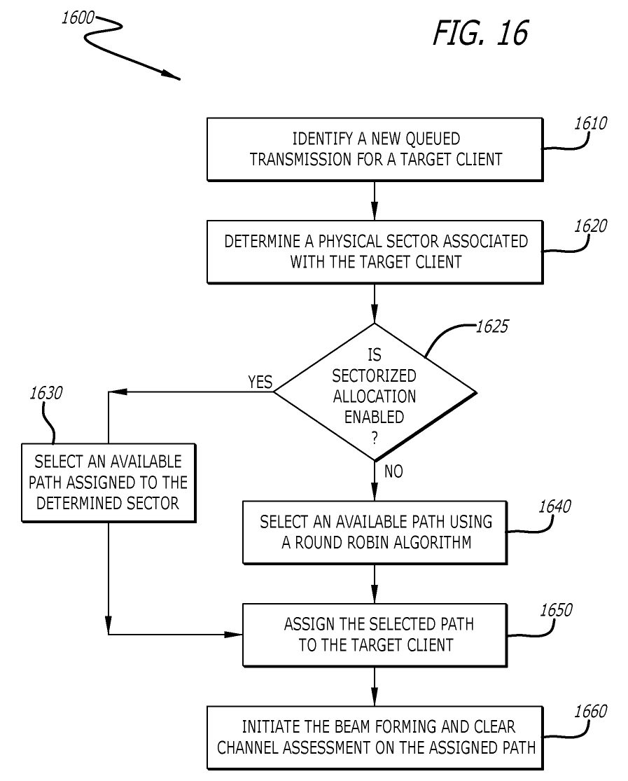

Referring to FIG. 16, a flowchart depicting a process 1600 for allocating reception and transmission paths in accordance with various embodiments of the disclosure is shown. The process 1600 can represent an advanced hardware management technique utilized by network devices operating in dense spatial environments. By intelligently distributing transmission tasks across multiple radio frequency paths, the system can maximize throughput and reduce localized congestion. This allocation strategy can be especially beneficial when deployed on a local machine acting as a central gateway for numerous portable devices demanding concurrent high-bandwidth connections.

In many embodiments, the process 1600 can identify a new queued transmission for a target client (block 1610). The identification might involve a remote device scanning incoming traffic buffers to locate physical layer protocol data units designated for specific end-users. For example, the process 1600 could monitor a primary transmit queue to detect priority video frames arriving from an upstream server. Alternatively, the process 1600 can continuously parse a localized caching system within a distributed environment to find pending sensor data updates. By accurately identifying these pending payloads, the system can initiate the resource allocation required to deliver the data across the millimeter wave spectrum.

In a number of embodiments, the process 1600 can determine a physical sector associated with the target client (block 1620). The determination might leverage historical connection data or recent sounding feedback to pinpoint the geographic location of a portable device relative to the antenna arrays. In another approach, the system can use specialized ranging protocols to continuously track the orientation of moving clients within the coverage area. For instance, a local machine could divide its surrounding space into distinct angular quadrants and assign the targeted device to one of those predefined areas. It is contemplated that this sector tracking can happen dynamically, allowing the network to adapt instantly as users walk through an office or public venue.

In more embodiments, the process 1600 can determine if sectorized allocation is enabled (block 1625). If it is determined that sectorized allocation is not enabled, then the process 1600 can select an available path using a round robin algorithm (block 1640). However, if sectorized allocation is enabled, then the process 1600 can select an available path assigned to the determined sector (block 1630). In certain embodiments, a network administrator can toggle the sectorized allocation settings based on the specific hardware capabilities of the deployment environment. In a non-limiting example, a remote device managing a sparse network might disable this feature to simplify path assignments, while a high-density enterprise node might mandate its use to prevent overlapping interference.

In further embodiments, the process 1600 can select an available path using a round robin algorithm (block 1640). The selection can involve cycling sequentially through a pool of available transceiver chains to ensure an even distribution of the transmission workload. Alternatively, the process 1600 might utilize a weighted round robin approach to favor specific high-performance antenna arrays over older or less capable hardware components. For example, a local machine serving as a basic hotspot could simply pick the next idle path in its sequence to handle an incoming request. This algorithmic selection can provide a straightforward and computationally inexpensive method for managing hardware resources across a distributed environment.

In additional embodiments, the process 1600 can select an available path assigned to the determined sector (block 1630). This targeted selection can restrict the hardware choices to only those transceiver paths specifically optimized or physically tuned to radiate energy into that geographic zone. In another scenario, the device might allocate a primary path for the sector and maintain a secondary backup path that can be utilized if the primary path is currently occupied by a concurrent operation. For instance, a sophisticated remote device could divide its radio frequency paths into four strict directional groupings to maintain complete spatial isolation. It is contemplated that selecting a path natively aligned with the client's location can drastically improve the efficiency of the subsequent beamforming procedures.

In still more embodiments, the process 1600 can assign the selected path to the target client (block 1650). The assignment might involve locking the digital logic counters and analog phase shifters associated with that path to the specific media access control address of the receiving device. Alternatively, the process 1600 could temporarily pair the path with a specific quality-of-service queue to ensure the data is transmitted according to strict timing parameters. For example, a node in a distributed environment can update its internal routing tables to reflect that a particular antenna array is now dedicated to servicing a specific neighboring node. Reserving the path in this manner can prevent internal race conditions where multiple software threads attempt to control the same hardware simultaneously.

In yet further embodiments, the process 1600 can initiate the beamforming and clear channel assessment on the assigned path (block 1660). The initiation can cause the assigned transceiver hardware to begin its backoff countdown while actively listening for any competing radio frequency energy in the designated spatial vector. In another approach, the assigned path might immediately apply phase corrections to focus its listening pattern precisely on the target client's location. For instance, a portable device could trigger its internal logic to evaluate the medium before sending a critical uplink transmission to the local network infrastructure. It is contemplated that multiple paths can execute this initiation step concurrently, leading to highly parallelized network access operations.

For example, the process 1600 can be deployed within a local machine serving as an advanced home network gateway. The gateway could identify a new queued transmission for a smart television and determine that the television is located in a specific living room sector. If the gateway has sectorized allocation enabled, it can bypass simple sequential assignment and actively select an available path assigned to the determined sector. By assigning the selected path strictly associated with the living room, the gateway can initiate the beamforming and clear channel assessment on the assigned path without inadvertently leaking interference into other areas of the house.

For instance, a remote device such as a cloud-managed enterprise access point might utilize the process 1600 to manage a fluid group of portable devices. When multiple smartphones request data simultaneously, the remote device might determine that sectorized allocation is disabled because the users are clustered closely together. In response, the remote device can select an available path using a round robin algorithm to rapidly push data payloads to the available transceivers. Once the paths are assigned to the respective target clients, the remote device can initiate the beamforming and clear channel assessment on the assigned paths concurrently, maximizing throughput despite the lack of strict sector isolation.

In a non-limiting example, the process 1600 can be executed by nodes operating within a decentralized distributed environment. A primary mesh router might identify a new queued transmission designated for a secondary mesh router located directly north. The primary router can determine the physical sector associated with the target client and select the northern-facing hardware path reserved specifically for that sector. By accurately assigning the selected path to the target client, the router can immediately initiate the beamforming and clear channel assessment on the assigned path, ensuring that the backhaul communication link remains stable and free of contention.

Although a specific embodiment for a process 1600 for allocating reception and transmission paths suitable for carrying out the various steps, processes, methods, and operations described herein is discussed with respect to FIG. 16, any of a variety of systems and/or processes may be utilized in accordance with embodiments of the disclosure. For example, the process 1600 can include a fallback mechanism to switch from sectorized allocation to round-robin allocation dynamically if specific hardware components experience temporary failures. Additionally, the use of optional embodiments does not indicate that the remaining elements are non-optional, but is presented to highlight a separate embodiment. The elements depicted in FIG. 16 may also be interchangeable with other elements of FIGS. 1–15 and 17-19 as required to realize a particularly desired embodiment.

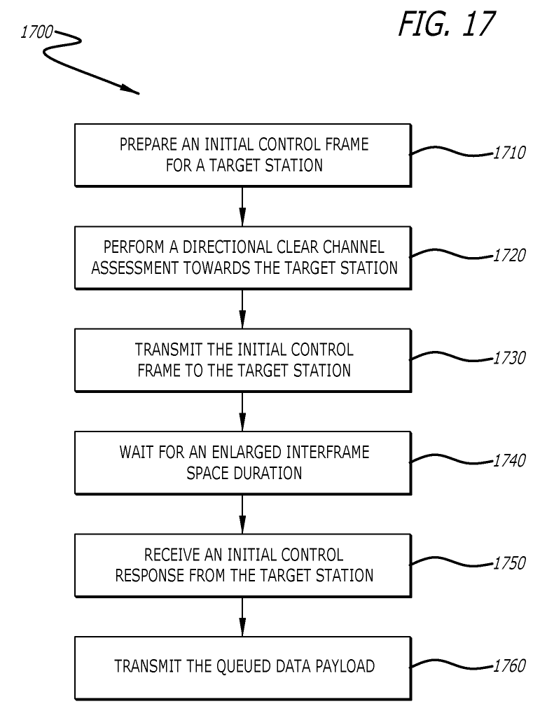

Referring to FIG. 17, a flowchart depicting a process 1700 for performing a directional clear channel assessment prior to an initial control frame in accordance with various embodiments of the disclosure is shown. The process 1700 can represent an advanced communication protocol for securing a wireless medium before transmitting large data payloads. By utilizing control frames and directional sensing, devices can effectively coordinate their actions to avoid collisions. This coordination can be particularly vital in distributed environments where multiple nodes might compete for the same radio frequency resources.

In many embodiments, the process 1700 can prepare an initial control frame for a target station (block 1710). The initial control frame might serve as a request to send a larger burst of data across the network. For example, a local machine could formulate this frame to alert a specific portable device that a high-priority packet is waiting in the queue. In another approach, the system can generate a customized control message that includes specific timing parameters and beamforming coordinates. It is contemplated that the preparation of this frame can occur dynamically as new data enters the transmission buffers.

In a number of embodiments, the process 1700 can perform a directional clear channel assessment towards the target station (block 1720). This assessment can involve utilizing a phased array antenna to listen for interfering energy strictly along the spatial vector connecting to the intended recipient. For instance, a remote device might electronically steer its listening capabilities to ensure the immediate corridor is free of conflicting transmissions. Alternatively, the assessment might involve a hybrid approach where multiple narrow beams are evaluated simultaneously to find the cleanest path. Evaluating the medium in this highly directional manner can allow the network node to ignore high-power noise originating from unrelated geographic sectors.

In more embodiments, the process 1700 can transmit the initial control frame to the target station (block 1730). The transmission can be executed using the same focused radio frequency beam that was utilized during the assessment phase. In a non-limiting example, a portable device could broadcast this frame to an access point to secure permission before uploading a large video file. Conversely, the transmission can be sent using a slightly wider beam pattern to account for potential movement of the target station. Sending the control frame can effectively reserve the wireless medium and warn neighboring devices to defer their own communications.

In further embodiments, the process 1700 can wait for an enlarged interframe space duration (block 1740). Waiting for this specific duration can provide the receiving device with adequate time to process the control frame, perform its own directional assessment, and formulate a response. For example, a node within a distributed environment might pause its transmission sequence for an extended microsecond interval to ensure the target has fully verified the channel conditions on its end. In another scenario, the duration of the wait can be dynamically adjusted based on the known processing capabilities of the targeted portable device. It is contemplated that the enlarged interframe space duration can be significantly longer than traditional standard interframe spaces to accommodate the complex directional sensing required in millimeter wave networks.

In additional embodiments, the process 1700 can receive an initial control response from the target station (block 1750). The reception might involve capturing a clear-to-send message that formally grants the transmitting device permission to proceed with its data payload. For instance, a local machine could maintain its antenna array in a highly directional receiving state to catch this faint response signal. Alternatively, the received message might contain updated beam steering coordinates if the target station has recently changed its physical location. Successfully capturing this response can act as the final verification that the spatial corridor is secured for high-throughput communication.

In still more embodiments, the process 1700 can transmit the queued data payload (block 1760). The transmission can leverage the fully negotiated and assessed millimeter wave link to deliver substantial amounts of information rapidly. In a non-limiting example, a remote device could utilize this secured channel to push a massive software update to an entire fleet of industrial sensors without fear of interruption. Conversely, the payload can consist of aggregated telemetry data gathered from various points across a distributed environment. Delivering the payload after the rigorous control frame exchange can ensure maximum reliability and minimize the need for costly retransmissions.

For example, the process 1700 can be deployed on a local machine functioning as a smart home hub to manage bandwidth-intensive communications with a portable device. The local machine could prepare an initial control frame for a target station, such as a virtual reality headset requiring a massive data stream. The local machine can then perform a directional clear channel assessment towards the target station to ensure the living room sector is free of interference. After the local machine can transmit the initial control frame to the target station, it can wait for an enlarged interframe space duration, allowing the headset to confirm the channel is clear on its end before the local machine can receive an initial control response from the target station and subsequently transmit the queued data payload.

For instance, a remote device operating as a cloud-managed enterprise access point might utilize the process 1700 to coordinate traffic in a crowded office. The remote device could have a large presentation file buffered and ready for delivery. By choosing to transmit the initial control frame to the target station after a focused medium check, the remote device can formally request a dedicated time block from the recipient laptop. The remote device can then wait for an enlarged interframe space duration to give the laptop time to perform a reciprocal check, ultimately allowing the remote device to safely transmit the queued data payload once the affirmative response is captured.

In a non-limiting example, the process 1700 can be utilized by peer nodes operating within a decentralized distributed environment to maintain robust backhaul links. A primary mesh node could identify a need to synchronize routing tables with a secondary node. The primary node can perform a directional clear channel assessment towards the target station to evaluate the specific spatial vector between the two outdoor antennas. By engaging in this careful handshake, including electing to wait for an enlarged interframe space duration to capture the response, the primary node can ensure that the critical routing information is successfully transmitted in the final step, preventing network-wide connectivity drops.

Although a specific embodiment for a process 1700 for performing a directional clear channel assessment prior to an initial control frame suitable for carrying out the various steps, processes, methods, and operations described herein is discussed with respect to FIG. 17, any of a variety of systems and/or processes may be utilized in accordance with embodiments of the disclosure. For example, the process 1700 can include additional security handshakes or cryptographic verifications during the control frame exchange phase. Additionally, the use of optional embodiments does not indicate that the remaining elements are non-optional, but is presented to highlight a separate embodiment. The elements depicted in FIG. 17 may also be interchangeable with other elements of FIGS. 1–16 and 18-19 as required to realize a particularly desired embodiment.

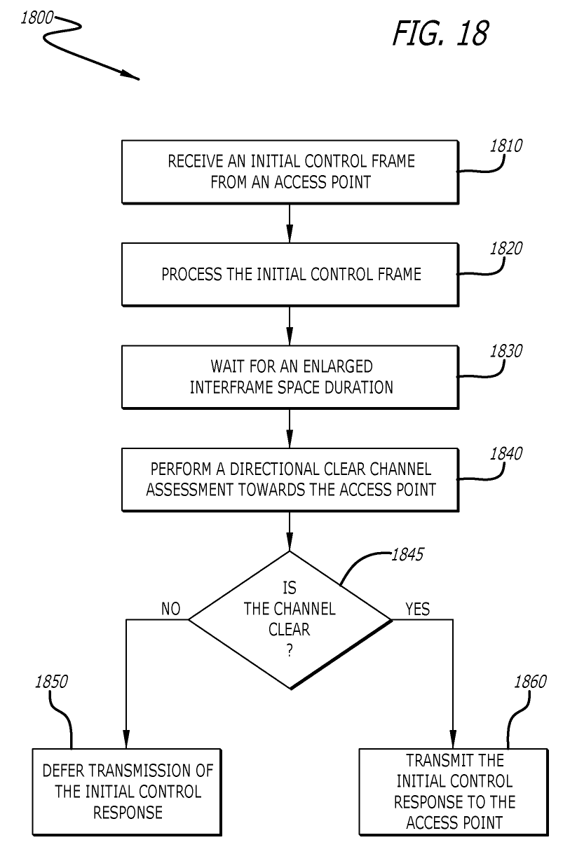

Referring to FIG. 18, a flowchart depicting a process 1800 for performing a directional clear channel assessment prior to an initial control response in accordance with various embodiments of the disclosure is shown. The process 1800 can represent the operational steps executed by a client device operating within a highly directional wireless environment. By carefully evaluating the medium before replying to management signals, devices can effectively coordinate their actions to prevent data collisions. This cautious response strategy can be particularly vital in distributed environments where multiple portable devices might compete for the same radio frequency resources.

In many embodiments, the process 1800 can receive an initial control frame from an access point (block 1810). For example, a portable device could capture a request-to-send message that is beamed directly to its physical location using millimeter wave frequencies. In another approach, a local machine serving as a smart home appliance might receive a unique wake-up beacon intended to establish a secure, high-bandwidth connection. It is contemplated that the reception of this frame can instantly trigger the receiving hardware to prepare for a subsequent, larger data payload. By capturing this initial frame, the device can become aware of an impending transmission opportunity originating from the network infrastructure.

In a number of embodiments, the process 1800 can process the initial control frame (block 1820). Processing the frame might involve demodulating the radio frequency signals to extract the underlying digital instructions and timing parameters. For instance, a remote device acting as an edge sensor could analyze the packet headers to ascertain the exact duration of the proposed transmission window. Alternatively, the processing step can include evaluating cryptographic signatures to verify that the request originated from a trusted node within the distributed environment. This processing logic can ensure that the device understands the network's scheduling intentions before taking further action.

In more embodiments, the process 1800 can wait for an enlarged interframe space duration (block 1830). Waiting for this specific interval can provide the receiving hardware with sufficient time to transition its antenna arrays from a receiving configuration to an active sensing configuration. For example, a portable device might utilize this extended pause to ensure that any residual radio frequency echoes in the environment have fully dissipated before conducting a channel check. It is contemplated that this extended delay can be significantly longer than standard short interframe spaces to accommodate the complex directional beam steering required by the protocol. This designated waiting period can synchronize the timing between the transmitting access point and the receiving client.

In further embodiments, the process 1800 can perform a directional clear channel assessment towards the access point (block 1840). This assessment can involve utilizing a phased array antenna to monitor for interfering energy strictly along the spatial vector connecting back to the transmitting source. For instance, a local machine might electronically steer its listening capabilities to ensure the immediate return corridor is free of conflicting data traffic. By evaluating the medium in this highly targeted manner, the network node can effectively ignore high-power noise originating from unrelated geographic sectors. The focused listening operation can verify that a response signal will not be corrupted upon transmission.

In additional embodiments, the process 1800 can determine if the channel is clear (block 1845). If it is determined that the channel is not clear, then the process 1800 can defer transmission of the initial control response (block 1850). However, if it is determined that the channel is clear, then the process 1800 can transmit the initial control response to the access point (block 1860). This decision-making process can rely on comparing the detected energy levels against a predetermined threshold value stored within the memory of the portable device. The binary outcome of this determination can dictate whether the device engages in the communication or backs down to prevent network instability.

In still more embodiments, the process 1800 can defer transmission of the initial control response (block 1850). Deferring the transmission might involve dropping the current communication sequence entirely and returning to a passive listening state to avoid a collision. For example, a remote device located in a busy industrial setting might wait for the access point to resend the initial control frame at a later time when the medium is less congested. It is contemplated that the system could log this deferral event locally to help administrators analyze interference patterns across the distributed environment. Yielding the medium in this manner can preserve the overall integrity of the shared wireless spectrum.

In yet further embodiments, the process 1800 can transmit the initial control response to the access point (block 1860). The transmission might be a highly focused clear-to-send signal that formally grants the access point permission to push its pending data payload. In a non-limiting example, a portable device could broadcast this confirmation using the exact same phase shifter settings that were utilized during the directional assessment. Sending this response can effectively finalize the reservation of the wireless medium, ensuring that both devices are synchronized and ready for the impending high-throughput data transfer. It is contemplated that successfully transmitting this frame will immediately initiate the primary data exchange phase.

For example, the process 1800 can be deployed on a local machine functioning as a smart television in a home automation setup. The local machine could receive an initial control frame from an access point indicating that a high-definition movie stream is queued. After the local machine has taken the time to process the initial control frame, it can wait for an enlarged interframe space duration to allow its internal transceivers to switch from receive to sense modes. By electing to perform a directional clear channel assessment towards the access point, the television can ensure the specific spatial path is free from interference caused by other smart devices before it can transmit the initial control response to the access point.

For instance, a portable device such as a modern smartphone might utilize the process 1800 to navigate a densely populated stadium network. The smartphone could capture a request from the network infrastructure and process the initial control frame to understand the requested transmission parameters. To prevent adding to the local congestion, the smartphone can wait for an enlarged interframe space duration and perform a directional clear channel assessment towards the access point. If the assessment reveals a sudden burst of interfering noise from a neighboring spectator, the smartphone can determine the channel is not clear and defer transmission of the initial control response, thereby preventing a costly data collision.

In a non-limiting example, the process 1800 can be utilized by a remote device operating within a decentralized distributed environment to maintain robust backhaul links. A secondary mesh node could receive an initial control frame from an access point functioning as the primary routing hub. The secondary node can process the initial control frame to identify the synchronization schedule and wait for an enlarged interframe space duration to align its hardware clocks. Upon deciding to perform a directional clear channel assessment towards the access point and confirming the space is quiet, the secondary node can safely transmit the initial control response to the access point, ensuring the mesh network remains perfectly synchronized.

Although a specific embodiment for a process 1800 for performing a directional clear channel assessment prior to an initial control response suitable for carrying out the various steps, processes, methods, and operations described herein is discussed with respect to FIG. 18, any of a variety of systems and/or processes may be utilized in accordance with embodiments of the disclosure. For example, the process 1800 can be adapted to bypass the wait period if the device possesses advanced full-duplex transceivers capable of simultaneously transmitting and listening. Additionally, the use of optional embodiments does not indicate that the remaining elements are non-optional, but is presented to highlight a separate embodiment. The elements depicted in FIG. 18 may also be interchangeable with other elements of FIGS. 1–17 and 19 as required to realize a particularly desired embodiment.

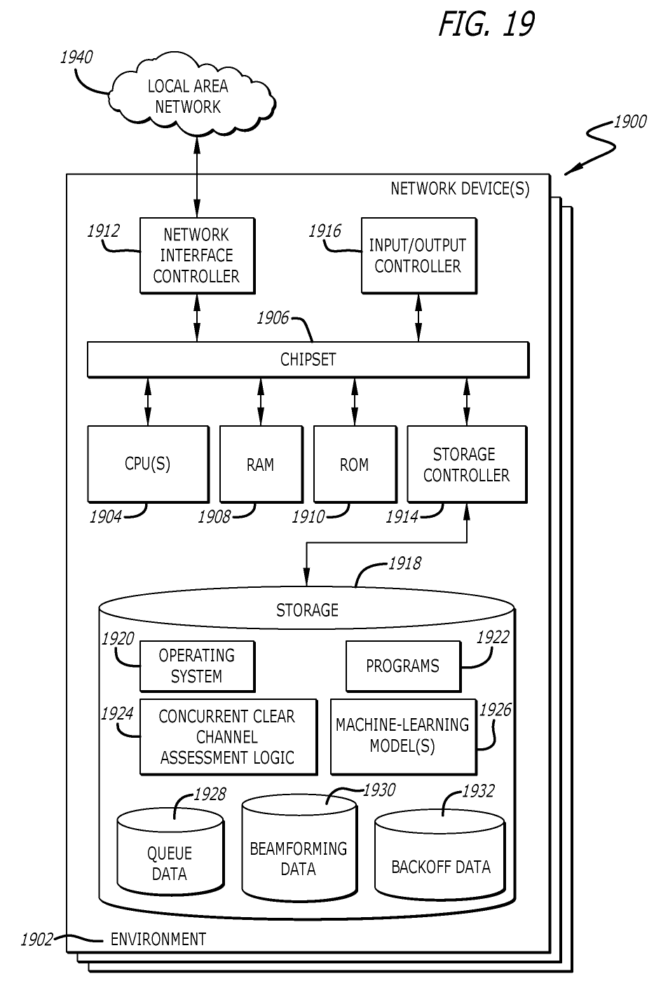

Referring to FIG. 19, a conceptual block diagram of a device 1900 suitable for configuration with a concurrent clear channel assessment logic 1924 for implementing the functionality and various embodiments of the disclosure is shown. The embodiment of the device 1900 in the conceptual block diagram depicted in FIG. 19 may relate to a conventional server computer, a workstation, a desktop computer, a laptop, a tablet, a network appliance, an electronic reader (e-reader), a smartphone, or other computing device, and can be utilized to execute any of the application and/or logic components presented herein. The device 1900 may, in some examples, correspond to a physical device or to a virtual resource described herein. The device 1900 can be a network device, for example, an access point, a router, a switch, any type of edge-based network device, a server, a system, or the like in accordance with various embodiments of the disclosure.

In many embodiments, the device 1900 may include an environment 1902, which may represent the overall operational context or physical assembly, such as a baseboard or a “motherboard,” in physical embodiments that can be configured as a printed circuit board with a multitude of components or devices connected by way of a system bus or other electrical communication paths. Conceptually, in virtualized embodiments, the environment 1902 may be a virtual environment that encompasses and executes the remaining components and resources of the device 1900. In a number of embodiments, CPU(s) 1904 such as, but not limited to, Central Processing Units, can be configured to operate in conjunction with a chipset 1906. The CPU(s) 1904 can be standard programmable CPUs that perform arithmetic and logical operations that may support the operation of the device 1900.

In a variety of embodiments, the CPU(s) 1904 can perform one or more operations by transitioning from one discrete, physical state to the next through the manipulation of switching elements that differentiate between and change these states. Switching elements generally can include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like.

In various embodiments, the chipset 1906 may provide an interface between the CPU(s) 1904 and the remainder of the components and devices within the device 1900. The chipset 1906 can provide an interface to a Random-Access Memory (RAM 1908), which can be utilized as the main memory in the device 1900 in some embodiments. The chipset 1906 can further be configured to provide an interface to a computer-readable storage medium such as a Read-Only Memory (ROM 1910) or a Non-Volatile RAM (NVRAM) for storing basic routines that can help with various tasks such as, but not limited to, starting up the device 1900 and/or transferring information between the various components and devices. The ROM 1910 or NVRAM can also store other application components that may support the operation of the device 1900 in accordance with various embodiments described herein.

Different embodiments of the device 1900 can be configured to operate in a networked environment using logical connections to remote computing devices and computer systems through a network, such as the local area network 1940. The chipset 1906 can include functionality for providing network connectivity through a network interface controller 1912 (or NIC), which may include a gigabit Ethernet adapter, a high-speed SerDes interface, or similar component. The network interface controller 1912 can be capable of connecting the device 1900 to other devices over the local area network 1940. It is contemplated that a network interface controller 1912, or multiple, may be present in the device 1900, connecting the device 1900 to other types of networks and remote systems. The device 1900 may also include other device(s) (not explicitly numbered but implied as connected to the input/output controller 1916 or system bus).

In more embodiments, the device 1900 can be connected to a storage 1918 that provides non-volatile storage for data accessible by the device 1900. The storage 1918 can, for example, store an operating system 1920, applications or programs 1922, queue data 1928, beamforming data 1930, and backoff data 1932, which are described in greater detail below. The storage 1918 can be connected to the main system components through a storage controller 1914 connected to the chipset 1906 or system bus.

In additional embodiments, the storage 1918 can include one or more physical storage units. The storage controller 1914 can interface with the physical storage units through interfaces such as a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units. The device 1900 can store data within the storage 1918 by transforming the physical state of the physical storage units to reflect the information being stored.

The specific transformation of the physical state can depend on various factors. Examples of such factors can include, but are not limited to, the technology utilized to implement the physical storage units, whether the storage 1918 is characterized as primary or secondary storage, and the like. For example, the device 1900 can store information within the storage 1918 by issuing instructions through the storage controller 1914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description.

The device 1900 can further read or access information from the storage 1918 by detecting the physical states or characteristics of one or more particular locations within the physical storage units. In addition to the storage 1918 described above, the device 1900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1900. In some examples, the operations performed by a cloud computing network, and or any components included therein, may be supported by one or more devices similar to the device 1900. Stated otherwise, some or all of the operations performed by a cloud computing network, and or any components included therein, may be performed by the device 1900 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1918 can store an operating system 1920 utilized to control the operation of the device 1900. According to one embodiment, the operating system 1920 includes the LINUX operating system. According to another embodiment, the operating system 1920 includes the Windows® server operating system from Microsoft Corporation. According to further embodiments, the operating system 1920 can include the UNIX operating system or one of its variants. It should be appreciated that other operating systems can also be utilized.

The storage 1918 can store other system or application programs and data utilized by the device 1900. In still more embodiments, the storage 1918 or other computer-readable storage media is encoded with computer-executable instructions which, when loaded into the device 1900, may transform the device 1900 from a general-purpose computing system into a special-purpose computer capable of implementing the embodiments described herein. These computer-executable instructions may be stored as applications or programs 1922 and transform the device 1900 by specifying how the CPU(s) 1904 can transition between states, as described above.

In still further embodiments, the device 1900 has access to computer-readable storage media storing computer-executable instructions which, when executed by the device 1900, perform the various processes described with regard to the flowcharts of the present disclosure. In still additional embodiments, the device 1900 can also include computer-readable storage media having instructions stored thereupon for performing any of the other computer-implemented operations described herein.

In some more embodiments, the device 1900 can also include one or more input/output controller 1916 for receiving and processing input from a number of input devices, such as a keyboard, a mouse, a touchpad, a touch screen, an electronic stylus, or other type of input device. Similarly, an input/output controller 1916 can be configured to provide output to a display, such as a computer monitor, a flat panel display, a digital projector, a printer, or other type of output device.

Those skilled in the art will recognize that the device 1900 may not include all of the components shown in FIG. 19, and can include other components that are not explicitly shown in FIG. 19, or may utilize an architecture completely different than that shown in FIG. 19. As described above, the device 1900 may support a virtualization layer, such as one or more virtual resources executing on the device 1900. In some examples, the virtualization layer may be supported by a hypervisor that provides one or more virtual machines running on the device 1900 to perform functions described herein. The virtualization layer may generally support a virtual resource that performs at least a portion of the techniques described herein.

The concurrent clear channel assessment logic 1924, in various embodiments, may represent a dedicated hardware circuit, a programmable logic device, a set of instructions executed by CPU(s) 1904, or a combination thereof, within the device 1900. This concurrent clear channel assessment logic 1924 can be configured to manage and regulate multiple medium access operations within the system, particularly those that may be critical for the operation of highly directional millimeter wave communications. It is contemplated that the concurrent clear channel assessment logic 1924 can implement processes for initiating independent backoff countdowns across different spatial sectors, monitoring internal radio frequency isolation, and applying dynamic beam shifting as described in various embodiments of the disclosure.

In certain embodiments, the concurrent clear channel assessment logic 1924 can actively monitor inputs such as queue data 1928, beamforming data 1930, and backoff data 1932 to make informed adjustments. For example, if queue data 1928 indicates new packets are pending for multiple devices, or if beamforming data 1930 signals that adequate spatial isolation exists between the targeted sectors, the concurrent clear channel assessment logic 1924 might initiate parallel listening operations to accelerate medium access. Similarly, based on real-time backoff data 1932, the concurrent clear channel assessment logic 1924 could implement dynamic pausing or beam re-allocation techniques to maintain the stability of active transmissions, ensuring consistent performance across varying traffic conditions within the device 1900. The operations of the concurrent clear channel assessment logic 1924 may facilitate a dense spatial reuse environment. The machine-learning model 1926, in some embodiments, may represent a computational engine or a set of algorithms configured to learn from data and make predictions or decisions without being explicitly programmed for every specific scenario. This machine-learning model 1926 can be executed by the CPU(s) 1904 or specialized hardware within device 1900 and may interact closely with the concurrent clear channel assessment logic 1924. It is contemplated that the machine-learning model 1926 could be trained using historical or simulated queue data 1928, beamforming data 1930, backoff data 1932, and potentially other system performance metrics to identify complex patterns and correlations relevant to spatial interference and transmission scheduling.

In certain embodiments, the machine-learning model 1926 can analyze incoming real-time data (queue data 1928, beamforming data 1930, backoff data 1932) and provide predictive insights or optimized control parameters to the concurrent clear channel assessment logic 1924. For example, it might predict impending radio frequency overlap based on current beamforming data 1930 and historical collision patterns stored in the queue data 1928, allowing the concurrent clear channel assessment logic 1924 to take proactive measures like deferring a secondary countdown. Furthermore, the machine-learning model 1926 could learn optimal settings for dynamic path allocation or isolation thresholds under various operating conditions to enhance spatial reuse, potentially adapting these settings over time as the network layout or environmental conditions change. This approach, leveraging a machine-learning model 1926, can enable more sophisticated, adaptive, and potentially more efficient operation of the concurrent clear channel assessment logic 1924 compared to traditional rigid scheduling methods.

The queue data 1928, in various embodiments, may encompass a range of scheduling metrics and payload parameters collected from the medium access control layer within the device 1900. This data could include, for example, the number of pending physical layer protocol data units waiting for transmission, the specific destination addresses of the targeted clients, or the quality-of-service priority tags attached to individual packets. Queue data 1928 might also include information about whether a response frame is required for a particular payload, which can be particularly relevant in determining if a supplemental omnidirectional assessment is necessary.

In certain embodiments, the concurrent clear channel assessment logic 1924 can utilize queue data 1928 as a key input for its decision-making processes associated with allocating hardware paths. By analyzing queue data 1928, the concurrent clear channel assessment logic 1924 can assess the immediate traffic demands placed on the system. If, for example, queue data 1928 reveals that multiple high-priority streams are destined for devices in distinct sectors, this information can trigger the concurrent clear channel assessment logic 1924 to activate parallel transceiver chains, significantly reducing the waiting time required to clear the buffers.

The beamforming data 1930, in many embodiments, may represent information pertaining to the spatial configuration, phase shifter settings, and directional orientation of the various antenna arrays within the device 1900. This data can include, but is not limited to, the exact electrical beam angles actively maintained by the transceiver hardware, the known locations of associated client devices relative to those angles, or the estimated isolation margins between adjacent spatial sectors. Beamforming data 1930 might also reflect current settings indicating whether a specific path is locked onto a target for data transmission or sweeping a sector during a clear channel assessment.

It is contemplated that the concurrent clear channel assessment logic 1924 can process beamforming data 1930 to anticipate or respond to internal interference conditions that could affect parallel operations. For example, if beamforming data 1930 indicates that a primary transmission beam overlaps slightly with the listening corridor of a secondary path, the concurrent clear channel assessment logic 1924 might proactively pause the secondary backoff counter to minimize false busy readings. Conversely, if beamforming data 1930 shows robust isolation between sectors, the logic might safely allow multiple countdowns to proceed simultaneously, while ensuring that the necessary spatial boundaries remain intact throughout the session.

The backoff data 1932, in some embodiments, may consist of the current timer values, pause states, and contention window sizes associated with the independent medium access operations within the device 1900. This data might include the real-time microsecond countdowns for each active path, flags indicating whether a specific timer is frozen due to internal transmission noise, or logs of recent collision events that might dictate an enlarged interframe space duration. Backoff data 1932 can provide the concurrent clear channel assessment logic 1924 with insights into the exact status of its parallel processing efforts.

It is contemplated that the concurrent clear channel assessment logic 1924 can utilize backoff data 1932 to implement precise timing coordination across the transceiver chains. Since the goal is to optimize airtime utilization without causing collisions, the concurrent clear channel assessment logic 1924 can use backoff data 1932 to make split-second alignment decisions. For example, it might monitor the remaining time on a paused counter from the backoff data 1932 and instantly resume the countdown the moment the interfering primary transmission ceases. This adjustment based on backoff data 1932 may further ensure that the device accurately honors the requisite waiting periods before dispatching its highly directional payloads.

Although a specific embodiment for a device 1900 suitable for configuration with the concurrent clear channel assessment logic 1924 for carrying out the various steps, processes, methods, and operations described herein is discussed with respect to FIG. 19, any of a variety of systems and/or processes may be utilized in accordance with embodiments of the disclosure. For example, the concurrent clear channel assessment logic 1924 could interface with additional types of sensor data beyond those explicitly shown, or the machine-learning model 1926 could be implemented using a distributed architecture across multiple processing elements within device 1900. The elements depicted in FIG. 19 may also be interchangeable with other elements of FIGS. 1–18 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor;
at least one network interface controller configured to provide access to a network; and
a memory communicatively coupled to the processor , wherein the memory comprises a concurrent clear channel assessment logic that is configured to:
identify a first target station for a first data transmission and a second target station for a second data transmission;
direct a first radio frequency beam towards the first target station and a second radio frequency beam towards the second target station;
initiate a first clear channel assessment countdown for the first target station concurrently with a second clear channel assessment countdown for the second target station based on a radio frequency isolation between the first radio frequency beam and the second radio frequency beam; and
transmit a first physical layer protocol data unit to the first target station upon completion of the first clear channel assessment countdown.

2. The network device of claim 1, wherein the concurrent clear channel assessment logic is further configured to transmit a second physical layer protocol data unit to the second target station upon completion of the second clear channel assessment countdown.

3. The network device of claim 1, wherein the concurrent clear channel assessment logic is further configured to:
determine that the transmission of the first physical layer protocol data unit interferes with the second clear channel assessment countdown; and
pause the second clear channel assessment countdown during the transmission of the first physical layer protocol data unit.

4. The network device of claim 3, wherein the concurrent clear channel assessment logic is further configured to resume the second clear channel assessment countdown after completion of the transmission of the first physical layer protocol data unit.

5. The network device of claim 1, wherein the concurrent clear channel assessment logic is further configured to:
determine that the radio frequency isolation between the first radio frequency beam and the second radio frequency beam is not sufficient; and
defer the second clear channel assessment countdown until the transmission of the first physical layer protocol data unit completes.

6. The network device of claim 1, wherein the concurrent clear channel assessment logic is further configured to:
determine that a response frame is expected from the first target station; and
perform an omnidirectional clear channel assessment to check medium clearance prior to transmitting the first physical layer protocol data unit.

7. The network device of claim 1, wherein the concurrent clear channel assessment logic is further configured to:
determine a physical sector associated with the first target station; and
select an available path assigned to the determined physical sector for the first radio frequency beam.

8. The network device of claim 7, wherein the concurrent clear channel assessment logic is further configured to:
determine that a sectorized allocation is disabled; and
select the available path using a round robin algorithm.

9. The network device of claim 1, wherein the concurrent clear channel assessment logic is further configured to receive a response frame from the first target station via the first radio frequency beam while concurrently performing the second clear channel assessment countdown via the second radio frequency beam.

10. The network device of claim 1, wherein the concurrent clear channel assessment logic is further configured to queue a first physical layer protocol data unit for the first target station and a second physical layer protocol data unit for the second target station prior to directing the first radio frequency beam and the second radio frequency beam.

11. A client device, comprising:
a processor;
at least one network interface controller configured to provide access to a network; and
a memory communicatively coupled to the processor, wherein the memory comprises a concurrent clear channel assessment logic that is configured to:
direct a receiving radio frequency beam;
receive a directional physical layer protocol data unit transmission;
process the directional physical layer protocol data unit transmission;
determine that a response frame is required; and
transmit a directional response frame.

12. The client device of claim 11, wherein radio frequency beam is directed toward a network device.

13. The client device of claim 12, wherein the directional physical layer protocol data unit transmission is received from the network device.

14. The client device of claim 13, wherein the requirement of a response frame is determined based on the directional physical layer protocol data unit transmission.

15. The client device of claim 14, wherein the directional response frame is transmitted to the network device.

16. The client device of claim 11, wherein the concurrent clear channel assessment logic is further configured to:
receive a second directional physical layer protocol data unit transmission;
determine that a second response frame is not required; and
return to a listening state.

17. The client device of claim 11, wherein the concurrent clear channel assessment logic is further configured to:
receive an initial control frame prior to receiving the directional physical layer protocol data unit transmission; and
wait for an enlarged interframe space duration.

18. The client device of claim 11, wherein the concurrent clear channel assessment logic is further configured to:
perform a directional clear channel assessment prior to transmitting the directional response frame.

19. The client device of claim 18, wherein the concurrent clear channel assessment logic is further configured to:
determine that a channel is not clear based on the directional clear channel assessment; and
defer transmission of the directional response frame.

20. A method of concurrent clear channel assessment, comprising:
identifying, by a network device, a first target station for a first data transmission and a second target station for a second data transmission;
directing, by the network device, a first radio frequency beam towards the first target station and a second radio frequency beam towards the second target station;
initiating, by the network device, a first clear channel assessment countdown for the first target station concurrently with a second clear channel assessment countdown for the second target station based on a radio frequency isolation between the first radio frequency beam and the second radio frequency beam; and
transmitting, by the network device, a first physical layer protocol data unit to the first target station upon completion of the first clear channel assessment countdown.
